(19) United States
(12) Patent Application Publication
(10) Pub. No.: US 2008/0093199 A1
(43) Pub. Date: Apr. 24, 2008

(54) Conveyor Cleaning Apparatus and Method

(76) Inventors: Dale J. Reynebeau, Little Chute, WI (US); Michael J. Bricco, Larsen, WI (US); Michael J. Romenesko, Kaukauna, WI (US); Gerald T. Kerkhoff, Little Chute, WI (US)

Correspondence Address: MICHAEL BEST & FRIEDRICH LLP, 100 E WISCONSIN AVENUE, Suite 3300, MILWAUKEE, WI, 53202, US

(21) Appl. No.: 11/575,659

(22) PCT Filed: Sep. 21, 2005
(86) PCT No.: PCT/US05/33644

§ 371 Date: Mar. 21, 2007

Related U.S. Application Data
(60) Provisional application No. 60/611,883, filed on Sep. 21, 2004.

(51) Int. Cl. B65G 45/18

(52) U.S. Cl. 198/496

(57) ABSTRACT

A conveyor cleaning brush assembly and method are disclosed. In some embodiments, the conveyor cleaning brush assembly comprises a brush coupled to a frame and movable to different positions with respect to a conveyor surface to be cleaned by the brush. The brush can be substantially elongated, and in some embodiments is rotatable about two or more axes that can extend in a machine direction of the conveyor surface, a cross-machine direction of the conveyor surface, or in any other direction therebetween. The brush can be coupled to and movable along a beam coupled to the frame, such as to move the brush to different cross-machine positions of the conveyor surface. Also, in some embodiments, the brush can be moved into and out of engagement with the conveyor surface. Such movement of the brush can be accomplished, for example, by movement of a beam to which the brush is coupled.

### CROSS-REFERENCE TO RELATED APPLICATIONS

Priority is hereby claimed to U.S. Provisional Patent Application No. 60/611,883 filed on Sep. 21, 2004, the entire contents of which are incorporated herein by reference.

### BACKGROUND OF THE INVENTION

A wide variety of conveying equipment exists for moving material of all types, including without limitation conveyors used to move pulp and paper material (e.g., in the process of manufacturing paper and paper products), conveyors used to transport stone, mineral, wood, food, chemical, synthetic, and other products, and conveyors used for still other purposes. In many such applications, the conveyor surface is subject to becoming embedded, entrained, coated, or otherwise soiled with matter during operation of the conveyor. By way of example only, pulp fibers can become embedded within wires and felts of a papermaking machine. In some cases, such matter can reduce the efficiency of the conveyor or the equipment associated with the conveyor. With reference again to papermaking machinery, pulp fibers embedded within the wires and felts of a papermaking machine can reduce the heating and drying efficiency of the papermaking machine, thereby significantly increasing operational and maintenance costs.

Although some types of conveyor cleaning equipment exist, many have shortcomings relating to cleaning effectiveness, mess associated with the conveyor cleaning process, equipment cost, and the like. New conveyor cleaning equipment is therefore welcome in the art.

### SUMMARY OF THE INVENTION

In some embodiments of the present invention, a conveyor cleaning apparatus for cleaning a conveyor surface moving in a machine direction is provided, and comprises a carriage movable to different cross-machine positions adjacent the conveyor surface, and a rotatable brush coupled to and movable with the carriage to the different cross machine positions with respect to the conveyor surface, the rotatable brush having at least one position in which the rotatable brush engages the conveyor surface to remove matter from the conveyor surface.

Some embodiments of the present invention provide a conveyor cleaning apparatus for cleaning a conveyor surface moving in a machine direction, wherein the conveyor cleaning assembly comprises a frame past which the conveyor surface moves, a controller having at least one user-manipulatable control, and a rotatable brush coupled to the frame and rotatable about at least one axis extending substantially in the machine direction, the rotatable brush electrically coupled to the controller and movable by the controller into and out of engagement with the conveyor surface.

In some embodiments, of the present invention, a conveyor cleaning apparatus for cleaning a conveyor surface is provided, and comprises a beam adjacent the conveyor surface and extending across the conveyor surface, a rotatable brush coupled to the beam, the rotatable brush adapted to engage the conveyor surface and to clean the conveyor surface upon rotation of the rotatable brush, and a motor coupled to the rotatable brush, the rotatable brush movable along the beam by the motor to different positions with respect to the conveyor surface to clean the different positions of the conveyor surface.

Further aspects of the present invention, together with the organization and operation thereof, will become apparent from the following detailed description of the invention when taken in conjunction with the accompanying drawings.

### BRIEF DESCRIPTION OF THE DRAWINGS

FIG. 1 is a front perspective view of a conveyor cleaning brush assembly according to a first embodiment of the present invention, shown installed on a papermaking machine and in an engaged state;

FIG. 2 is a front perspective view of the conveyor cleaning brush assembly illustrated in FIG. 1, shown installed on a papermaking machine and in a retracted state;

FIG. 3 is a partial exploded rear perspective view of the conveyor cleaning brush assembly illustrated in FIGS. 1 and 2;

FIG. 4 is an exploded front perspective view of the beam and frame assembly illustrated in FIGS. 1-3;

FIG. 5 is an exploded front perspective view of the brush assembly and the carriage illustrated in FIGS. 1-3;

FIG. 6 is a sectioned front perspective view of the conveyor cleaning brush assembly illustrated in FIGS. 1-5, shown with a dust collector and installed on a papermaking machine in an engaged state;

FIG. 7 is another sectioned front perspective view of the conveyor cleaning brush assembly, dust collector, and papermaking machine illustrated in FIG. 6;

FIG. 8 is a front perspective view of a conveyor cleaning brush assembly according to a second embodiment of the present invention, shown installed on a papermaking machine and in an engaged state;

FIG. 9 is a front perspective view of a conveyor cleaning brush assembly according to a third embodiment of the present invention, shown installed on a papermaking machine and in an engaged state;

FIG. 10 is a front perspective view of a conveyor cleaning brush assembly according to a fourth embodiment of the present invention, shown installed on a papermaking machine and in an engaged state;

FIG. 11 is a rear perspective view of the conveyor cleaning brush assembly illustrated in FIG. 10;

FIG. 12 is a front perspective view of a conveyor cleaning brush assembly according to a fifth embodiment of the present invention, shown installed on a papermaking machine and in an engaged state;

FIG. 13 is a front perspective view of a conveyor cleaning brush assembly according to a sixth embodiment of the present invention, shown installed on a papermaking machine and in an engaged state; and

FIG. 14 is an elevational view of controls for the conveyor brush cleaning assembly according to an embodiment of the present invention.

Before the various embodiments of the present invention are explained in detail, it is to be understood that the invention is not limited in its application to the details of construction and the arrangements of components set forth in the following description or illustrated in the drawings. The invention is capable of other embodiments and of being practiced or of being carried out in various ways. Also, it is to be understood that phraseology and terminology used herein with reference to device or element orientation (such as, for example, terms like “front,” “back,” “up,” “down,” “top,” “bottom,” and the like) are only used to simplify description of the present invention, and do not alone indicate or imply that the device or element referred to must have a particular orientation. In addition, terms such as “first,” “second,” and “third” are used herein and in the appended claims for purposes of description and are not intended to indicate or imply relative importance or significance. The use of “including,” “comprising,” or “having” and variations thereof herein is meant to encompass the items listed thereafter and equivalents thereof as well as additional items. Unless limited otherwise, the terms “connected,” “coupled,” and variations thereof herein are used broadly and encompass direct and indirect connections and couplings. In addition, the terms “connected” and “coupled” and variations thereof are not restricted to physical or mechanical connections or couplings.

### DETAILED DESCRIPTION

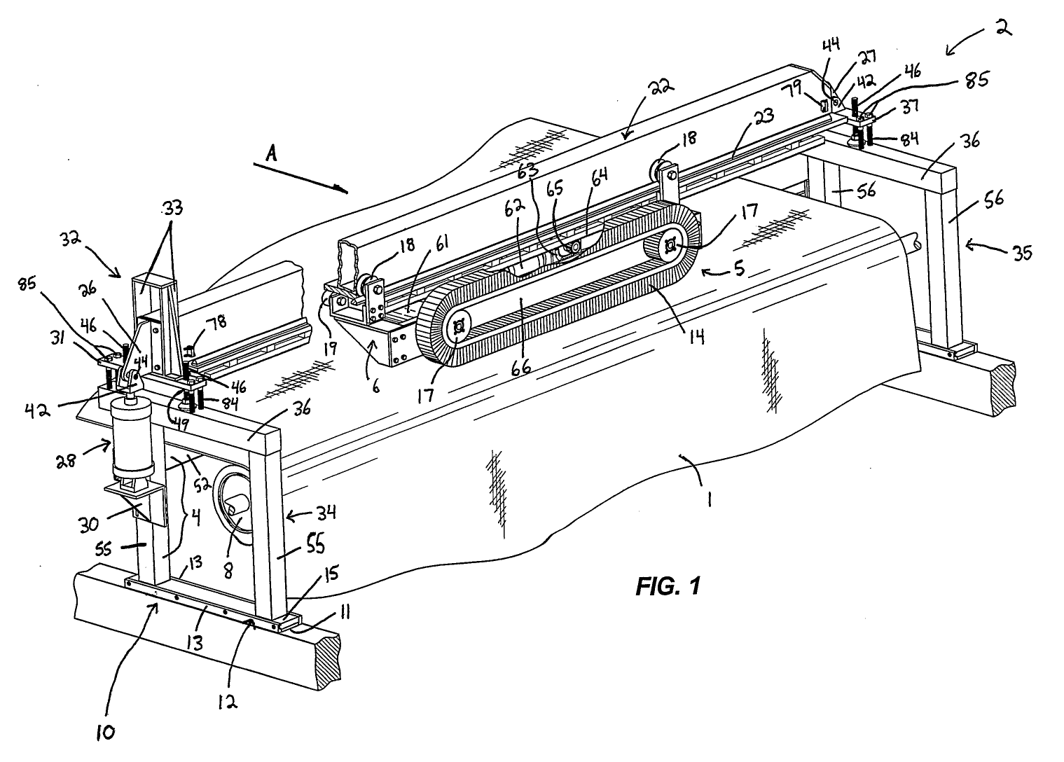

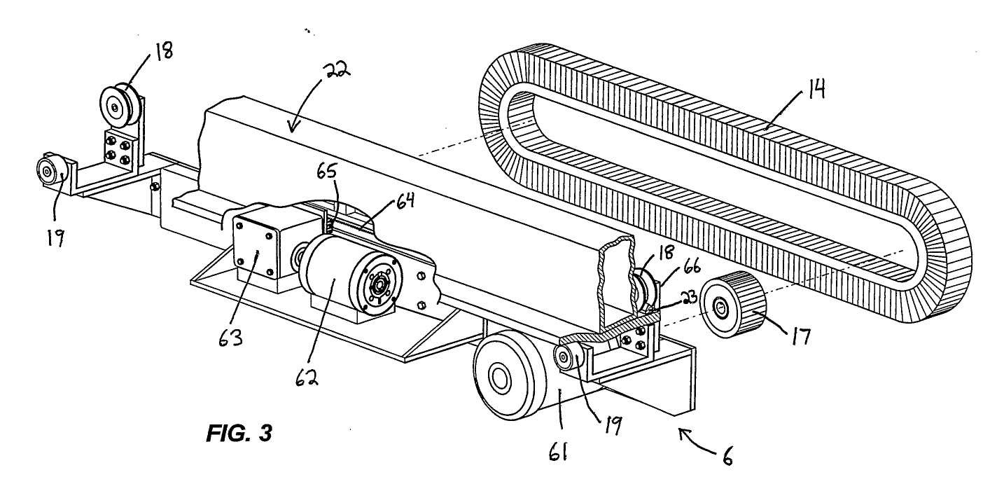

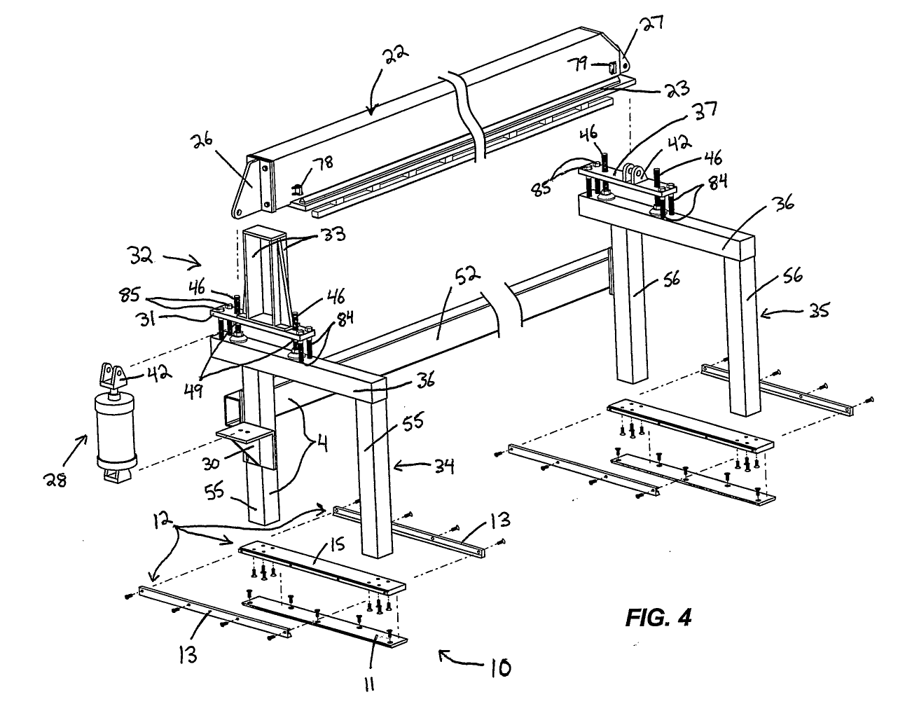

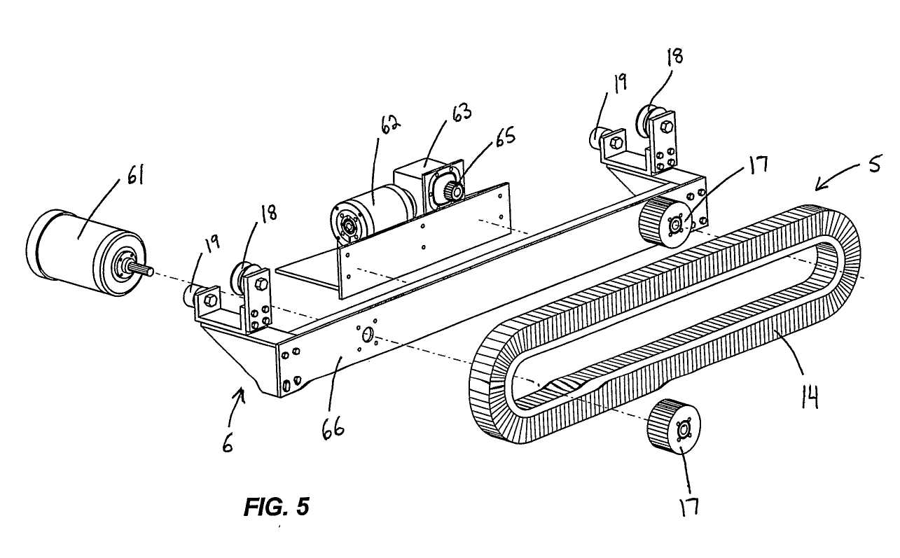

With reference to FIGS. 1-5, a conveyor cleaning brush assembly according to an embodiment of the present invention is shown, and is indicated generally at 2. The conveyor cleaning brush assembly 2 illustrated in FIGS. 1-5 comprises a frame 4, a beam 22 coupled to the frame 4, a carriage 6 movable along the beam 22, and a brush assembly 5 coupled to and movable with the carriage 6. As will be described in greater detail below, the brush assembly 5 includes a brush 14 movable with respect to a conveyor surface 1 (e.g., a dryer felt in the illustrated embodiment of FIGS. 1-5) to clean the conveyor surface 1. The illustrated conveyor cleaning brush assembly 2 can also be controlled to move the brush 14 into and out of engagement with the conveyor surface 1 by movement of the beam 22, as will also be described in greater detail below.

The conveyor cleaning brush assembly 2 can be installed in a number of different types of equipment in order to clean many different types of conveying surfaces. By way of example only, the conveyor cleaning brush assembly 2 illustrated in FIGS. 1-5 is installed on a papermaking machine for cleaning a dryer felt (conveyor surface 1). As another example, the conveyor cleaning brush assembly 2 illustrated in FIGS. 1-5 can be installed on a papermaking machine for cleaning a wet felt for the purpose of raising the felt surface or “nap” in order to maintain desired felt dewatering properties. As other examples, the conveyor cleaning brush assembly 2 can be installed in other areas of a papermaking machine, such as for cleaning a paper forming wire or fabric of a papermaking machine, or for cleaning the surface of a roll 8 (e.g., when the conveyor cleaning brush assembly 2 is installed adjacent a soft calendar roll, hard steel roll, dryer can, or any other type of rotating conveyor surface).

Still other applications for the conveyor cleaning brush assembly 2 include installations directly against a paper web in paper manufacturing, winding, and/or reeling machinery (e.g., in order to de-lint a web surface, in installations directly against a paper web surface where the sheet consistency is between 30-40% for the purpose of embossing, surface glazing, or other sheet altering functions, and the like). In other applications, the conveyor cleaning brush assembly 2 can be installed to clean conveyor belts, conveyor tabletops, wires, felts, fabrics, or any other material conveying surface used in any type of equipment. Examples of equipment types include processing and/or moving equipment for aggregate, minerals, pulp, paper, paperboard, wood, polymer, cement, ceramic and other refractory material, composites, food and food by-products, and the like. It should also be noted that in some applications, the conveyor cleaning brush assembly 2 can be installed adjacent stationary or temporarily stationary surfaces in order to clean such surfaces.

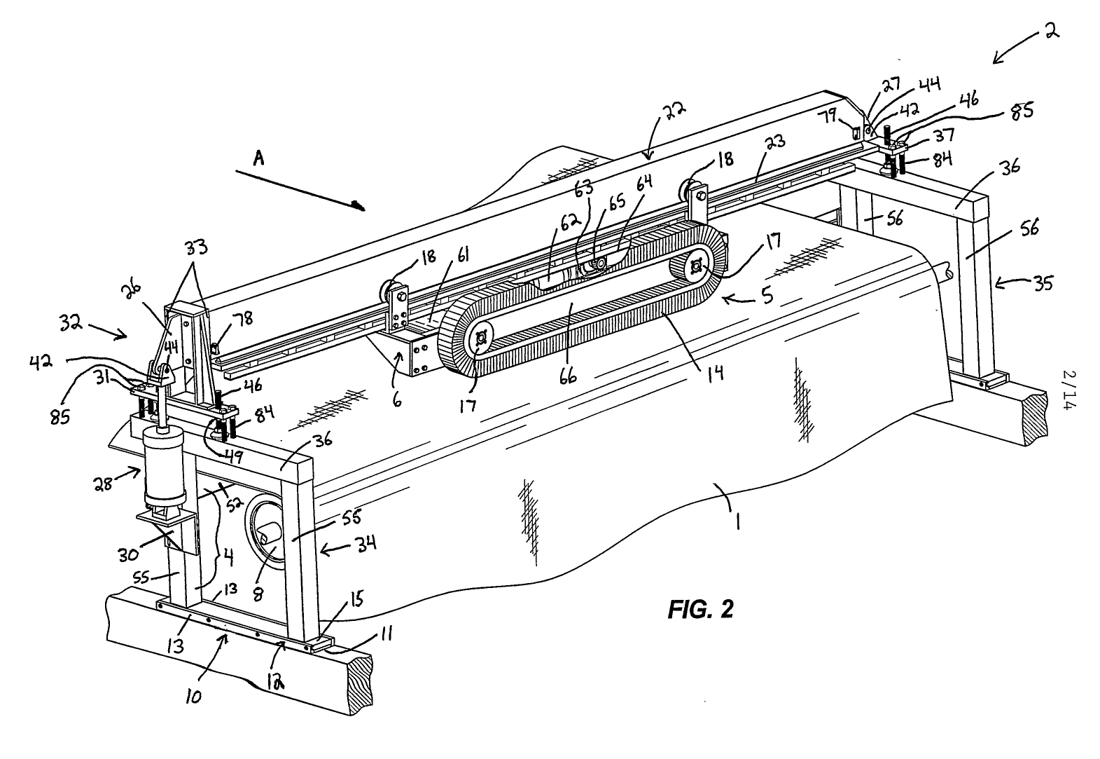

Also, the conveyor surface 1 to be cleaned by the conveyor cleaning brush assembly 2 can have any shape and size, and can move in any manner. For example, the conveyor surface 1 illustrated in FIGS. 1 and 2 moves in a machine direction (indicated by arrow A) over a roll. The conveyor surface 1 can run in an elongated loop, in a circular, triangular, rectangular, trapezoidal, or any other polygonal path about any number of rolls or other elements, or in any other regular or irregular path about any number of such elements. In still other embodiments, the conveyor surface 1 does not run about two or more elements, and instead is coupled to or defined by a movable material conveying element. For example, the conveyor surface 1 can be a conveying sheet or other material coupled to a roll or other rotating element, or can be defined by a surface of a roll or other rotating element.

The conveyor cleaning brush assembly 2 illustrated in FIGS. 1-5 is shown installed with the beam 22 in a substantially horizontal orientation above a conveyor surface 1, thereby positioning the brush 14 over the conveyor surface 1 being cleaned. It should be noted that this location and orientation of the conveyor cleaning brush assembly 2 with respect to the conveyor surface 1 is only one of many that can be utilized to clean a conveyor surface 1. The conveyor cleaning brush assembly 2 can be installed in any orientation to clean either side of a conveyor surface 1 running in a horizontal direction, a vertical direction, or in any diagonal direction therebetween at a location where the conveyor surface 1 passes the conveyor cleaning brush assembly 2. In any of such applications, the beam 22 can be oriented horizontally, vertically, or in any diagonal orientation therebetween in order to position the brush 14 in contact with the conveyor surface 1.

Referring again to FIGS. 1-5, the beam 22 in the illustrated embodiment is a hollow tubular member spanning across the conveyor surface 1. Like the other elements of the conveyor cleaning brush assembly 2 described and illustrated herein, the beam 22 can have any shape and size (e.g., solid or tubular, thinner or thicker than that shown in FIGS. 1-4, having a rectangular, round, or any other cross-sectional shape), and can be constructed of any material or combination of materials, such as steel, aluminum, iron, or other metals, wood, plastic, fiberglass, composite materials, and the like.

In some embodiments, the beam 22 is shaped to enable the carriage 6 to move therealong. For example, the beam 22 illustrated in FIGS. 1-4 has a track 23 along which the carriage 6 moves, as will be described in greater detail below. The track 23 can be defined at least in part by a flange or lip of or coupled to the beam 22, and can extend along any portion or all of the beam 22. In some embodiments, the track 23 is substantially flat. In other embodiments, the track 23 is substantially L (see FIGS. 1-4), V, or U-shaped, or has any other shape suitable for movement of the carriage 6 therealong.

The beam 22 illustrated in FIGS. 1-4 is coupled at both ends to the frame 4 of the conveyor cleaning brush assembly 2. The frame 4 can have any shape and size desired, depending at least in part upon the environment, orientation, and equipment in which the conveyor cleaning brush assembly 2 is installed. In the application shown by way of example on FIGS. 1 and 2, the frame 4 comprises supports 34, 35 on opposite sides of the conveyor surface 1. The supports 34, 35 can be coupled together by a stretcher 52 in order to provide additional strength and stability to the frame 4. The stretcher 52 can be a beam as shown in FIGS. 1-4, or can be one or more other elements connecting the supports 34, across the conveyor surface 1 (e.g., plates, rods, angles, bars, and the like). Although the stretcher 52 illustrated in FIGS. 1-4 is positioned to extend across the conveyor surface 1 on a side of the conveyor surface 1 opposite the brush 14, in other embodiments the stretcher 52 is located on the same side of the conveyor surface 1.

The supports 34, 35 of the frame 4 illustrated in FIGS. 1-4 are located at substantially the same position along the machine direction of the conveyor surface 1, whereby the beam 22 extends substantially perpendicularly with respect to the machine direction of the conveyor surface 1. However, in other embodiments, the supports 34, 35 can be positioned in any other manner with respect to one another on opposite sides of the conveyor surface 1. In such embodiments, the beam 22 can extend across the conveyor surface 1 at any angle with respect to the machine direction. For example, the beam 22 can extend at a 30, 45, or 60 degree angle or at any other substantial angle with respect to the machine direction. In such embodiments, the carriage 6 and brush 14 move upstream and downstream as they move along the beam 22 (described in greater detail below) and/or the brush 14 rotates about one or more axes oriented at an angle between the machine and cross-machine directions of the conveyor surface 1 (e.g., at a 30, 45, or 60 degree angle or at any other substantial angle with respect to the machine direction).

Each support 34, 35 in the illustrated embodiment of FIGS. 1-5 includes a pair of legs 55, 56 for support of the conveyor cleaning brush assembly 2, although either or both supports 34, 35 can have a single leg or any number of additional legs in other embodiments. The legs 55, 56 extend toward and are coupled to a location on a floor, a wall, a papermaking machine frame or platform (not shown), or other structure to which the conveyor cleaning brush assembly 2 is mounted. The legs 55, 56 can be constructed of any type and number of components, and of any material or combination of materials, such as steel, aluminum, iron, or other metals, wood, plastic, fiberglass, composite materials, and the like. In the illustrated embodiment of FIGS. 1-5, the legs 55, 56 are tubular members.

In some embodiments, either or both supports 34, 35 further comprise a mount 10 for mounting the frame 4 to a floor, wall, ceiling, frame, platform, or other structure as just described. In the illustrated embodiment of FIGS. 1-5, for example, each support 34, 35 has a mount 10 having male and female portions 11, 12 that permit the supports 34, 35 (and therefore, the frame 4) to be manually or automatically moved and secured to multiple positions with respect to the conveyor surface 1, such as to different positions along the machine direction of the conveyor surface 1 or to multiple conveyor surfaces 1. With particular reference to FIGS. 1, 2, and 4, the illustrated mount 10 has male and female portions 11, 12 mated in a dovetail configuration, wherein the male portion 11 can be permanently or releasably coupled to a floor, wall, ceiling, frame, platform, or other structure (e.g., by a series of bolts passed therethrough), and the female portion 12 can be mounted in sliding engagement atop the male portion 11. In other embodiments, the positions of the male and female portions are reversed. Also in other embodiments, any other type of male and female mounting connections can be utilized as desired, some of which enable one of the male and female portions to be secured to the other of the male and female portions in two or more positions.

Each portion 11, 12 of either or both mounts 10 can be defined by a single element or two or more elements coupled together in any suitable manner, such as by welds, brazing, bolts, screws, pins, nails, rivets, or other conventional fasteners, by clasps, clamps, or other fastening devices, by inter-engaging elements or features on the mount portions 11, 12, and the like. For example, the male portion 11 of each mount 10 illustrated in FIGS. 1, 2, and 4 is a single element, while the female portion 12 of each mount 10 comprises two side portions 13 bolted to a center plate 15, thereby enabling the female portion 12 to be removed from the male portion 11 without the need to slide the frame 4 therealong.

The supports 34, 35 of the frame 4 can be adjustably or non-adjustably mounted to a surface in a number of other manners falling within the spirit and scope of the present invention. For example, either or both mounts 10 can include a beam, tube, or other element coupled to the legs 55, 56 of the supports 34, 35 and adapted to be mounted to a floor, wall, ceiling, frame, platform, or other structure. In still other embodiments, one or more of the legs 55, 56 can be directly mounted to a surface, such as by bolts passed through one or more flanges on each leg 55, 56, by welding or brazing, and the like.

With continued reference to the illustrated embodiment of FIGS. 1-5, the supports 34, 35 of the frame 4 each include a stretcher 36 used to support other portions of the frame 4, including the portions of the frame 4 to which the beam 22 is mounted, as will be described in greater detail below. The stretcher 36 of each support 34, 35 can be a tubular element (such as the legs 55, 56 described above), or can take any other form desired. Also, the stretcher 36 of each support 34, 35 in the embodiment of FIGS. 1-5 connects the legs 55, 56 of each support 34, 35.

It will be appreciated that the frame 4 of the conveyor cleaning brush assembly 2 can be supported by supports 34, 35 having different structures than those described above and illustrated in FIGS. 1, 2, and 4. For example, in other embodiments falling within the spirit and scope of the present invention, each support 34, 35 can be constructed of any combination of tubes, beams, bars, angles, rods, plates, grids, or other elements while still performing the same functions described above.

In some embodiments, the frame 4 is provided with one or more guides for guiding movement of the beam 22 during operation of the conveyor cleaning brush assembly 2. As will be described in greater detail below, the beam 22 is movable in some embodiments in order to change the position of the brush 14 with respect to the conveyor surface 1 (e.g., to move the brush 14 into and out of engagement with the conveyor surface 1). To guide the beam 22 in this movement, the frame 4 illustrated in FIGS. 1, 2, and 4 can include a guide 32 coupled to the support 34 on one end of the beam 22. In other embodiments, a guide 32 is located at each end of the beam 22, and/or can be located between the ends of the beam 22 (in which case the guide 32 can be mounted to a frame, bracket, or other structure coupled to the stretcher 52 or other portion of the frame 4).

The guide 32 illustrated in FIGS. 1, 2, and 4 includes a pair of uprights 33 coupled to a base 31 and between which the beam 22 extends. The uprights 33 can be plates supported by gussets as shown, or can take any other form capable of preventing the beam 22 from laterally shifting during movement toward and away from the conveyor surface 1. For example, the upstanding members 33 can instead be plates without gussets, rods or tubes extending from the base 31, and the like.

In the illustrated embodiment of FIGS. 1-5, the base 31 of the guide 32 provides support to the beam 22, and at least partially defines a range of movement of the beam 22 with respect to the conveyor surface 1. In this regard, the beam 22 can be supported upon the base 31 when lowered into a position in which the brush 14 engages the conveyor surface 1. The lowest position of the beam 22 can be at least partially defined in other manners, such as by one or more stops positioned to directly or indirectly limit downward movement of the beam, by a lower limit of the actuator 28 (described below), and the like.

In some embodiments, the base 31 (and therefore, the guide 32) is adjustable to different positions, thereby adjusting the range of movement of the beam 22 and the resulting range of movement of the beam 22 with respect to the conveyor surface 1. In the illustrated embodiment of FIGS. 1-5, for example, the base 31 is adjustable to different positions with respect to the support 34, thereby changing the lowest position of the beam 22. With particular reference to FIGS. 1, 2, and 4, the illustrated base 31 is supported by two threaded rods 46 threaded into threaded apertures in the base 31. More or fewer threaded rods 46 can be utilized in other embodiments. Each threaded rod 46 has a foot supported by the support 34 and permitting the threaded rod 46 to turn in order to raise and lower the base 31 and the rest of the guide 32. Nuts 49 on the threaded rods 46 secure the base 31 at a desired height with respect to the support 34.

In other embodiments, other elements and devices can be used to adjust the position of the guide 32 with respect to the support 34. For example, the threaded rods 46 can be threaded into threaded holes in the support 34, and can be provided with collars supporting the guide 32 in a range of desired positions. As another example, one or more pneumatic or hydraulic cylinders can be coupled to the guide 32 for raising and lowering the guide. In other embodiments, any type of jack (e.g., a ratchet and pawl jack, ACME or screw jack, and the like) can be employed for the same purpose. In still other embodiments, the guide 32 can be supported upon a bladder that can be filled or evaluated to change the position of the guide. Still other manners of adjusting the position of the guide are possible, and fall within the spirit and scope of the present invention. It should also be noted that the threaded rods 46 and other adjustment devices and mechanisms described herein can be driven in a number of different manners, such as by a motor connected to turn the threaded rods 46, one or more solenoids or motors connected to other jack mechanisms to adjust such mechanisms, and the like.

With continued reference to the illustrated embodiment of FIGS. 1-5, the frame 4 includes additional threaded rods 84 extending through holes in the base 31 and through threaded holes in the support 34. Nuts 85 threaded upon the ends of the additional threaded rods 84 can prevent or limit upward movement of the guide 32. In other embodiments, upward movement of the guide 32 can be limited in other manners, such as by an adjustable or non-adjustable clamp between the support 34 and the guide 32, by one or more stops on the frame 4 positioned to directly or indirectly prevent movement of the guide 32 past a desired vertical position, and the like.

As shown in FIGS. 1, 2, and 4, the frame 4 in the illustrated embodiment is provided with a second base 37 on an end of the beam 22 opposite the guide 32. With the exception of the uprights 33 on the guide 32, the second base 37 is substantially the same as the base 31 of the guide 32, has the same associated elements for adjusting, supporting, and limiting movement of the second base 37 (e.g., threaded rods 46, 84 and nuts 49, 85), and can take any of the alternative forms described above in connection with the guide 32 in order to adjust, support, and limit movement of the second base 37.

As discussed in greater detail below, in some embodiments of the present invention, both ends of the beam 22 are movable to different vertical positions to engage and disengage the brush 14 with the conveyor surface 1 (rather than pivoting the beam 22 about an end of the beam 22). In such embodiments, guides 32 with uprights 33 can be located on opposite ends of the beam 32 and/or in any other location therebetween. For example, the second base 37 illustrated in FIGS. 1, 2, and 4 can be modified to include uprights 33 in embodiments in which both ends of the beam 22 are movable as just described.

The beam 22 in the illustrated embodiment of FIGS. 1-5 is mounted for movement with respect to the conveyor surface 1 by clevis and pin connections at the opposite ends of the beam 22. Specifically, brackets 26, 27 can be defined on or coupled to the opposite ends of the beam 22, and can be mated via a pin 44 to a clevis 42 at either end of the beam 22. Alternatively, a clevis 42 can be defined by or coupled to either or both opposite ends of the beam 22, and can be coupled to a bracket 26, 27 supported by the frame 4. The brackets 26, 27 illustrated in FIGS. 1, 2, and 4 are coupled to a clevis 42 coupled to the actuator 28 (described below), and to a clevis 42 coupled to the second base 37, respectively. The clevis and pin connections at the opposite ends of the beam 22 enable the beam 22 to pivot with respect to the frame 4 and conveyor surface 1.

In other embodiments, the beam 22 can be coupled to the actuator 28 and to the second base 35 in other manners, some of which permit rotation of the beam 22 and others (more appropriate for non-rotating beams as described below) that do not. For example, either or both ends of the beam 22 can be coupled to the frame 4 by a ball and socket joint, by any other type of pin-and-aperture connection (i.e., not necessarily clevis and pin connections), by bolts, screws, rivets, nails, and other fasteners securing the ends of the beam 22 to a suitable mount on the frame 4, and the like, all of which fall within the spirit and scope of the present invention.

As described above, an end of the beam 22 illustrated in FIGS. 1, 2, and 4 is coupled to an actuator 28. The actuator 28 illustrated in FIGS. 1, 2, and 4 is coupled to the frame 4 by a bracket 30. The bracket 30 is bolted to the support 34, although the bracket 30 can instead be coupled to the support by welding, brazing, screws, pins, nails, rivets, or other conventional fasteners, by clasps, clamps, or other fastening devices, by inter-engaging elements or features on the bracket 30 and frame 4, and the like.

The actuator 28 is actuatable to move the beam 22 with respect to the conveyor surface 1, lifting and lowering the end of the beam 22 to which the actuator 28 is coupled. When the beam 22 is lifted and lowered as just described, the opposite end of the beam 22 pivots about the hinge pin 44 coupled to the bracket 27 at the opposite end of the beam 22. The actuator 28 illustrated in FIGS. 1, 2, and 4 is a pneumatic cylinder driven by a source of compressed air (not shown) and operable by controls 60 coupled to the actuator 28. In other embodiments, other types of actuators can instead be utilized, including without limitation hydraulic actuators, ball and screw, ACME thread, rack and pinion, pawl and ratchet or other mechanical actuators driven by one or more pneumatic, hydraulic, or electric motors, and the like.

The controls 60 used to control operation of the actuator 28 can include microprocessor-based or analog controls, if desired. Alternatively, the actuator 28 can be manually actuated by a user via one or more manual or solenoid-driven valves (e.g., for pneumatic or hydraulic actuators), by one or more electrical switches, and the like.

With continued reference to the illustrated embodiment of FIGS. 1-5, the conveyor cleaning brush assembly 2 includes a carriage 6 coupled to and movable along the beam 22. The carriage 6 supports the brush 14, a motor 61 driving the brush 14, and a motor 62 operable to move the carriage 6 along the beam 22. The carriage 6 can have any shape and size and can be constructed of any number and types of elements for this purpose, including without limitation one or more plates, grids, beams, bars, angles, rods, tubes, or other elements connected together in any suitable manner (e.g., those described above in connection with mount portions 11, 12 having multiple pieces). In the illustrated embodiment of FIGS. 1-5, the carriage 6 comprises a plurality of plates connected in a shape providing mounting and support surfaces for the brush 14 and motors 61, 62 thereon.

The carriage 6 illustrated in FIGS. 1-3 and 5 is connected to the beam 22 by rollers 18, 19 rotatably coupled to the carriage and movable along the beam 22. The rollers 18, 19 in the illustrated embodiment of FIGS. 1-5 include a pair of rollers 18 positioned to roll along the track 23 of the beam 22, and a pair of rollers 19 positioned to roll along an underside surface of the beam 22, thereby retaining a portion of the beam 22 between the pairs of rollers 18, 19. In other embodiments, a single roller 18 or three or more rollers 18 can be positioned to roll along the track 23, and/or a single roller 19 or three or more rollers 19 can be positioned to roll along the underside of the beam 22. Also, in other embodiments one or more of the rollers 18, 19 can be coupled to the carriage 6 in a different location and/or the beam 22 can have a different cross-sectional shape, thereby permitting the rollers 18, 19 to connect the carriage 6 and beam 22 in other manners, such as one or more rollers 18 positioned to roll along one track 23 on the beam 22 and one or more rollers 19 positioned to roll along another similar track 23 of the beam (not shown) located on an opposite side of the beam 22. As another example, one or more rollers 18, 19 can be positioned to roll along a track or surface inside the beam 22, such as by one or more portions of the carriage 6 extending into an elongated aperture (not shown) running in a wall of the beam 22 and in which the roller(s) can roll. Still other manners of coupling the carriage 6 to the beam 22 with one or more rollers 18, 19 permitting movement of the carriage 6 along the beam 22 are possible, and fall within the spirit and scope of the present invention.

In some alternative embodiments, the carriage 6 is coupled to and movable along the beam 22 in other manners, such as by a series of rollers rotatably mounted to the beam 22 and across which the carriage 6 can roll in movement along the beam 22. As another example, the carriage 6 can move along the beam 22 by one or more linear bearings mounted to the carriage 6 and/or to the beam 22, one or more ball bearing sets located between the carriage 6 and beam 22, one or more low-friction pads of any shape located on the carriage 6 and/or beam 22, and the like.

With reference again to the illustrated embodiment of FIGS. 1-5, the carriage 6 is moved along the beam 22 by a motor 62 coupled to and carried by the carriage 6. The motor 62 is a hydraulic motor coupled to and supported by a portion of the carriage 6, and is connected to hydraulic lines (not shown) running beneath and along the beam 22 to a location adjacent the support 34 at which the hydraulic lines are coupled to a source of hydraulic fluid under pressure (also not shown). In other embodiments, other types of motors or driving devices can be utilized to drive the carriage 6. For example, the motor 62 can instead be a pneumatic motor or an electric motor connected to a source of pressurized air or electricity, respectively, via one or more lines running along the beam 22 as described above.

The motor 62 illustrated in the embodiment of FIGS. 1-5 is coupled to a gearbox 63 in order to reduce the output speed used for driving the carriage 6 along the beam 22. Like the motor 62, the gearbox 63 is coupled to and supported by a portion of the carriage 6. The illustrated gearbox 63 is drivably coupled to a gear 65 in driving engagement with a gear rack 64 coupled to the underside of the beam 22. In other embodiments, the gearbox 63 can be located in a different position with respect to the beam 22 (e.g., by virtue of a different shape of the carriage 6 and/or a different position of the carriage 6 with respect to the beam 22) in order to engage a gear rack 64 located elsewhere on the beam 22, such as on a side or top of the beam 22. Also, in other embodiments the motor 62 is drivably coupled to the gear rack 64 without use of a gearbox 63, such as in cases in which a variable speed drive is employed. In such embodiments, the gear 65 can be coupled directly to the output shaft of the motor 62, if desired.

In other embodiments, the carriage 6 can be moved along the beam 22 in other manners falling within the spirit and scope of the present invention. For example, the carriage 6 can instead be driven by a pulley or sprocket engaged with a cable, chain, or belt, itself driven by a motor. The cable, chain, or belt can extend along the beam 22 to enable the carriage 6 to move therealong as the motor is driven. As another example, the carriage 6 can be threaded upon one or more threaded rods (e.g., via a ballscrew connection) extending along the beam 22 and rotatable in a conventional manner to move the carriage 6 along the beam 22.

As described above, the motor 62 and gearbox 63 (if employed) can be coupled to and carried by the carriage 6 for moving the carriage 6 along the beam 22. In other embodiments, the motor 62 and gearbox 63 (if employed) can instead be coupled to the beam 22 and/or to either support 34, 35, stretcher 52, or other part of the frame 4 while still being drivably coupled to the carriage 6 in order to move the carriage 6 along the beam 22. For example, the motor 62 can be mounted to a surface of the beam 22 and can drive a gear, pulley, sprocket, or other element drivably engaged with a belt (toothed, flat, V-shaped, or otherwise), chain, cable, or other flexible element. The belt, chain, cable, or other flexible element can extend to and be coupled to the carriage 6, thereby causing the carriage 6 to move along the beam 22 when the motor 62 is activated.

It should be noted that, in some cases, the mechanism utilized to move the carriage 6 along the beam 22 can be sufficient to connect the carriage 6 to the beam 22 so that rollers, bearings, low-friction pads, or other additional elements or devices are not needed to perform or help perform this function.

The conveyor cleaning brush assembly 2 illustrated in FIGS. 1-5 includes a brush 14 coupled to and carried by the carriage 6 as described above. The brush 14 is coupled to the carriage 6 by a mounting plate 66 coupled to or integral with the carriage 6. The motor 61 driving the brush 14 in the embodiment of FIGS. 1-5 is also mounted to the mounting plate 66, and has a drive shaft extending through an aperture in the mounting plate 66 to drive the brush 14. In other embodiments, the brush 14 and/or the motor 61 is coupled to the carriage 6 in other manners, such as by being mounted to another frame or other structure coupled to the carriage 6.

The motor 61 driving the brush 14 is an air motor, and is connected to a pneumatic line (not shown) running beneath and along the beam 22 to a location adjacent the support 34 at which the pneumatic line is coupled to a source of air under pressure (also not shown). A significant advantage of using an air motor 61 to drive the brush 14 is that the exhaust of the air motor 61 can be directed toward the rollers 18, 19 and/or track 23, or toward any other structure utilized to movably connect the carriage 6 to the beam 22 as described above, in order to help clear that structure of debris or other matter that might otherwise accumulate during operation of the conveyor cleaning brush assembly 2. In other embodiments, other types of motors or driving devices can be utilized to drive the brush 14. For example, the motor 61 can instead be a hydraulic motor or an electric motor connected to a source of pressurized fluid or electricity, respectively, via one or more lines running along the beam 22 as described above.

The brush 14 in the illustrated embodiment of FIGS. 1-5 is substantially elongated, and extends about two pulleys 17 spaced a distance apart, one of which is drivably coupled to the motor 61. In other embodiments, the brush 14 can extend and be driven about any other number of pulleys 17 or other elements rotatable about respective axes. For example, the brush 14 can be rotatable about a single axis. As another example, the brush can be an elongated element driven about two, three, or more elements having any arrangement to bring the brush 14 into contact with the conveyor surface 1.

The brush 14 illustrated in the embodiment of FIGS. 1-5 is substantially elongated to define a length extending in the cross-machine direction. In some embodiments, the brush 14 has a length that is less than the width of the conveyor surface 1. For example, the brush 14 in the illustrated embodiment of FIGS. 1-5 has a length that is a fraction of the width of the conveyor surface 1. In some embodiments, the brush 14 has a length that is less than half the width of the conveyor surface 1. The brush 14 can comprise a plurality of bristles made of any material, including without limitation brass, copper, steel, or other metal, plastic, natural fiber, and the like.

As described above, the carriage 6 can be moved along the beam 22 by virtue of the manner in which the carriage 6 is connected thereto. Therefore, the brush 14 is movable by the carriage 6 to different locations with respect to the conveyor surface 1, thereby enabling an operator to clean desired portions of the conveyor surface 1 and/or to clean portions of the conveyor surface 1 in a desired order or pattern. In some embodiments, the user can operate the carriage 6 manually or in an automated manner (described below in connection with the controls 60) in order to move the carriage 6 along the beam 22. In the illustrated embodiment of FIGS. 1-5, for example, the motor 62 is activated to turn the gear 65 in engagement with the gear rack 64, thereby moving the carriage 6, brush motor 61, and brush 14 along the beam. In some embodiments, the motor 62 is reversible, thereby enabling the carriage 6 to be moved in both directions along the beam 22.

The carriage 6 in the embodiment of FIGS. 1-5 is movable across substantially the entire width of the conveyor surface 1. However, in other embodiments, the carriage 6 is movable across any fraction of the conveyor surface width. By moving the carriage 6 along the beam 22, the brush 14 can have a sweeping motion across the conveyor surface 1, thereby cleaning different cross-machine areas of the conveyor surface 1.

As also described above, the beam 22 is coupled to the actuator 28, which can move the beam 22 with respect to the conveyor surface 1 to lift and lower the end of the beam 22 to which the actuator 28 is coupled. In this manner, the brush 14 can be moved toward and away from the conveyor surface 1, and in some embodiments can be brought into and out of engagement with the conveyor surface 1, as best shown in FIGS. 1 and 2, respectively.

In some embodiments, motion of the carriage 6 along the beam 22 is limited in one or more manners in order to confine the carriage 6 to a range of positions on the beam 22. For example, an encoder or other device can be utilized in conjunction with motor 62 in order to detect the number of rotations of the gear 65, thereby detecting the travel distance of the carriage 6. As another example, one or more mechanical stops can be located on the beam 22, carriage 6, and/or other location on the conveyor cleaning brush assembly 2 in order to mechanically block further movement of the carriage 6 along the beam 22. In still other embodiments, one or more sensors can be positioned to detect the location of the carriage 6 along the beam 22. For example, the conveyor cleaning brush assembly 2 can have one or more optical, magnetic, pressure, mechanical (e.g., trip switches) or other sensors located on the beam 22, carriage 6, and/or other location on the conveyor cleaning brush assembly 2 in order to detect when the carriage 6 has reached one or more locations along the beam 22. Such sensors can be coupled directly to the motor 62 or can be coupled indirectly to the motor 62 (e.g., through the controls 60) in order to control the motor 62. In the illustrated embodiment of FIGS. 1-5, two mechanical sensors 78, 79 are mounted at opposite ends of the beam 22 and are tripped by the carriage 6 in its movement along the beam 22.

When the carriage 6 reaches either sensor 78, 79 (or is stopped by a mechanical stop, or when an encoder detects that the carriage 6 has been moved a particular distance as described above with regard to other embodiments), a signal can be sent to the controller 60 to reverse the motor 62. Alternatively, the signal can be sent to the controller 60 to stop movement of the carriage 6 and/or to lift the beam 22 using the actuator 28, if desired. In either case, the conveyor cleaning brush assembly 2 can be provided with a timer (e.g., as a component of the controller 60 or as a separate component coupled to the motor 62) that can provide a delay to the carriage 6 prior to reversing or stopping as just described. In this manner, the brush 14 can remain in a location proximate an end of its travel range for a sufficient period of time to insure that all portions of the conveyor surface 1 are fully cleaned.

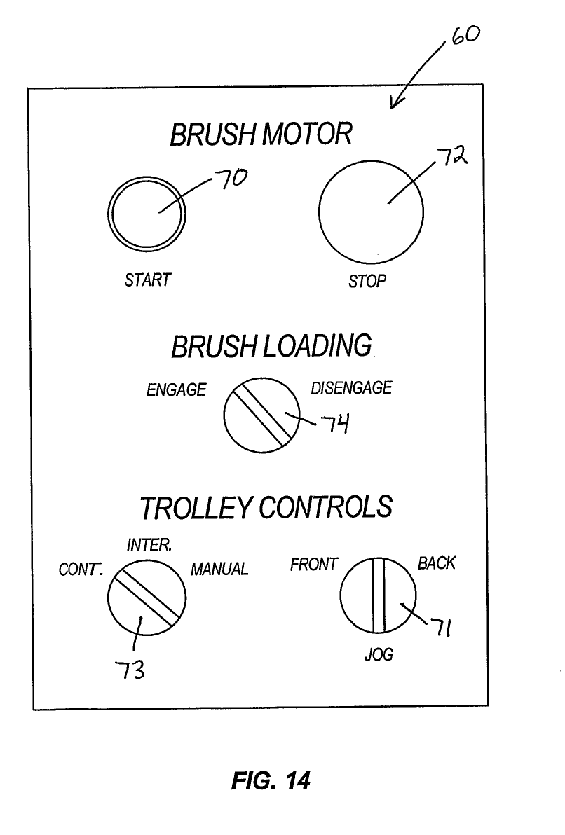

With reference now to FIG. 14, an example of controls 60 for the conveyor cleaning brush assembly 2 illustrated in FIGS. 1-5 is shown. The controls illustrated in FIG. 14 include start and stop buttons 70, 72 for the brush motor 61 in order to start or stop the brush 14, a switch 74 for the actuator 28 in order to raise and lower the beam 22 to disengage and engage the brush 14 with the conveyor surface 1, respectively, a carriage operational mode switch 73 to change the operational mode of the carriage 6, and a carriage motion switch 71 for the carriage motor 62 in order to move the carriage 6 in different directions along the beam 22. The carriage operational mode switch 73 can enable a user to manually control movement of the carriage 6 along the beam 22, such as by moving the carriage motion switch 71 to forward, backward, or jog positions while the carriage operational mode switch 73 is in manual position. Also, the carriage operational mode switch 73 can enable a user to place the carriage 6 in an automated mode in which the carriage automatically travels back and forth along the beam 22 at a desired rate of speed. Furthermore, the carriage operational mode switch 73 can enable a user to place the carriage 6 in a semi-automated mode in which the carriage 6 automatically travels as just described, but can also be temporarily manually overridden by operation of the carriage motion switch 71.

It will be appreciated that other types of controls can be utilized for any of the user-manipulatable controls illustrated in FIG. 14, including without limitation buttons, switches, knobs, and the like. Also, fewer or more controls 60 can be provided in other embodiments. For example, the controls 60 can include one or more user-manipulatable speed controls to adjust the speed of the brush 14, carriage 6, and/or beam 22, in other embodiments.

In some embodiments, one or more microprocessor or analog-based controllers (not shown) can be utilized to control operation of some or all of the conveyor cleaning brush assembly 2. For example, one or more such controllers can be coupled to the user controls 60 described above for controlling operation of either or both motors 61, 62 and/or the actuator 28. As another example, one or more controllers can automate a portion or all of the conveyor cleaning brush assembly 2, such as by engaging and disengaging the brush 14 by movement of the beam 22, by turning the brush 14 on or off, by changing the brush speed, by moving the carriage 6, and/or by changing the carriage speed.

Any one of these functions or a combination of any of these functions can be performed in response to an event, such as by user operation of a control 60, by one or more optical, magnetic, pressure, mechanical, or other sensors positioned to detect the location and/or speed of the carriage 6, the speed and/or appearance of the conveyor surface (e.g., dirty or clean), an operational state of the machine in which the conveyor cleaning brush assembly 2 is installed (e.g., on or off, conveyor surface speed, and the like), or another input.

For example, the motor 61 driving the brush 14 can be automatically activated or increased in speed upon movement of the beam 22 toward a position in which the brush 14 is engaged with the conveyor surface 1, and can be automatically de-activated or decreased in speed upon movement of the beam 22 toward a position in which the brush 14 is disengaged from the conveyor surface 1. As another example, the motor 62 driving the carriage 6 can be automatically activated or increased in speed upon movement of the beam 22 toward a position in which the brush 14 is engaged with the conveyor surface 1, and can be automatically de-activated or decreased in speed upon movement of the beam 22 toward a position in which the brush 14 is disengaged from the conveyor surface 1.

Also or instead, the actuator 28 can be automatically activated to raise the beam 22 responsive to the brush 14 being stopped or slowed to or below a threshold speed, and can be automatically activated to lower the beam 22 responsive to the brush 14 being started or increased in speed to or over a threshold speed. In some embodiments, the carriage motor 62 can be automatically activated to automatically stop or decrease the speed of the carriage 6 responsive to the brush 14 being stopped or slowed to or below a threshold speed, and can be automatically activated to start or increase the speed of the carriage 6 responsive to the brush 14 being started or increased in speed to or over a threshold speed.

As yet another example, the actuator 28 can be automatically activated to raise the beam 22 responsive to the carriage 6 being stopped or slowed to or below a threshold speed, and can be automatically activated to lower the beam 22 responsive to the carriage 6 being moved or increased in speed to or over a threshold speed. In some embodiments, the motor 61 driving the brush 14 can be automatically de-activated or decreased in speed responsive to the carriage 6 being stopped or slowed to or below a threshold speed, and can be automatically activated or increased in speed responsive to the carriage 6 being moved or increased in speed to or over a threshold speed.

Also, any of the system functions described herein can be controlled at least in part by one or more timers, whether such timers are in the form of separate components coupled to the motors 61, 62 or actuator 28, are part of a microprocessor or analog-based controller as described above, or are in another form. For example, in some embodiments the actuator 28 is operated to engage the brush 14 only after a period of time has passed following activation of the brush 14, thereby enabling the brush 14 to reach a desired cleaning speed before engaging the conveyor surface 1.

Any of the beam, brush, and carriage operations described above can also or instead be performed responsive to still other events, including without limitation the start or stop of the conveyor surface 1 (e.g., automatically lowering the beam 22, starting or speeding up carriage movement, and/or starting or speeding up brush movement responsive to movement of the conveyor surface 1, automatically raising the beam 22, slowing or stopping carriage movement, and/or slowing or stopping brush movement responsive to stopping of the conveyor surface 1, and the like). As another example, the beam 22 can be automatically raised, the carriage motor 62 can be automatically slowed or stopped, and/or the brush motor 61 can be automatically slowed or stopped upon detection of an overheating condition in any part of the conveyor cleaning brush assembly 2 or equipment in which the conveyor cleaning brush assembly is installed, upon operation of a safety switch, or upon obstruction of brush or beam movement.

In some embodiments, the carriage 6 is automatically returned to a home position when the beam 22 is retracted. Any location along the beam can be the home position of the carriage 6. For example, in the illustrated embodiment of FIGS. 1-5, the carriage 6 automatically returns to an end of the beam 22 adjacent the actuator 28 upon retraction of the beam 22. This function can instead be performed responsive to the brush 14 being stopped or sufficiently slowed.

In operation of the illustrated embodiment of FIGS. 1-5, the conveyor cleaning brush assembly 2 can be automatically activated or can be manually activated by the user controls described above. In a non-operational or standby mode, the carriage 6 is located toward an end of the beam 22 adjacent the actuator 28, and is retracted from the conveyor surface 1 by virtue of the beam 22 being in an elevated position. Upon activation of the conveyor cleaning brush assembly 2, the brush motor 61 starts. When the brush 14 reaches a desired speed (e.g., after a timed period has passed or upon detection of a threshold brush speed in any suitable manner), the actuator 28 lowers the beam 22 to a position in which the brush 14 is at a desired vertical position relative to the conveyor surface 1. The distance between the beam 22 and the conveyor surface 1 can be adjusted by vertical adjustment of the bases 31, 37 via threaded rods 46, 84 as described above and/or by control of the actuator 28. In this manner, the degree of engagement between the brush 14 and the conveyor surface 1 can be controlled, thereby controlling the strength of the sweeping force across the conveyor surface 1.

Upon lowering the beam 22 to a desired position, the carriage motor 62 will drive the carriage 6 back and forth between the ends of the beam 22. The carriage 6 is driven by the carriage motor 62 at a relatively low speed, such as at a rate of 1-10 feet per minute, but can be driven at faster or slower speeds depending at least in part upon factors such as the size and material of the brush 14, the width, length, or material of the conveyor surface 1, and other factors. The sensors 78, 79 detecting the position of the carriage 6 on the beam 22 send signals as described above to slow down, stop, and/or change direction of the carriage 6. It should be noted that the direction of rotation of the brush 14 can be changed in some embodiments. This function can be performed manually in some embodiments, or can be performed automatically (based upon the direction of motion of the carriage 6, whereby the surface of the brush 14 in engagement with the conveyor surface 1 travels in the same or opposite direction as the direction of movement of the carriage 6).

Other modes of conveyor cleaning brush assembly operation are possible and fall within the spirit and scope of the present invention. For example, in other operational modes, the brush 14 is lowered with the carriage 6 before activating or increasing the speed of the brush motor 61.

The bristles of the brush 14 are drawn across the conveyor surface 1, and sweep debris and other matter from the conveyor surface 1 in a generally lateral direction. In some embodiments, the brush 14 performs a self-cleaning function by movement of the bristles about the ends of the brush 14 as the brush 14 rotates about pulley 17. In particular, the bristles of the brush 14 can “fan out” as they round the ends of the brush 14, thereby releasing matter entrained within and between the bristles. This self-cleaning feature can be enhanced by the engagement of the brush 14 with the conveyor surface 1. (Bristles under compression against the conveyor surface 1 are released from this compression as they move about an end of the brush 14. This releasing action can cause matter entrained within and between the bristles to be ejected from the brush 14.)

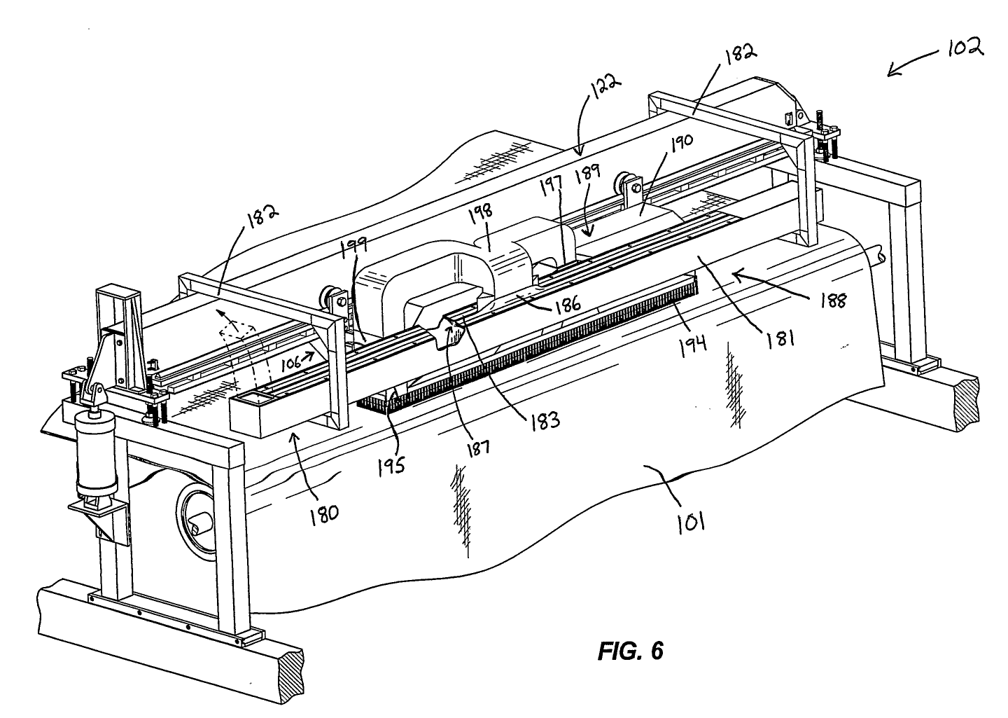

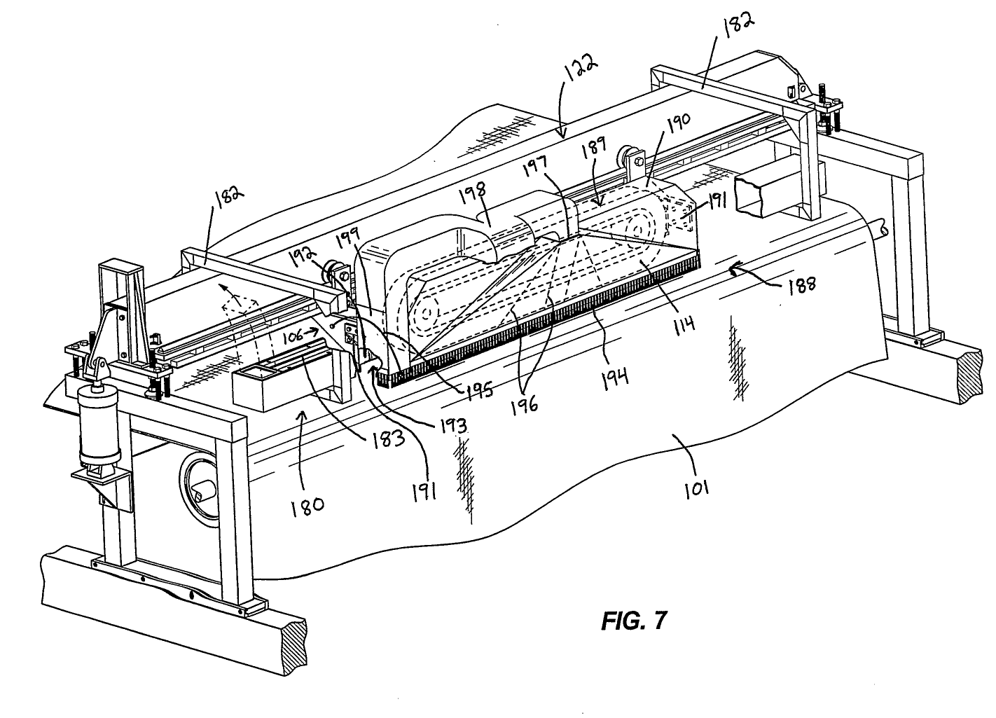

FIGS. 6 and 7 illustrate another conveyor cleaning brush assembly according to the present invention. The elements and features of this embodiment are similar in many ways to elements and features in the embodiment described above and illustrated in FIGS. 1-5 and 14. Accordingly, the following description focuses primarily upon those elements and features that are different from the embodiment described above. Reference should be made to the above description for additional information regarding the elements, features, and possible alternatives to the elements and features of the conveyor cleaning brush assembly illustrated in FIGS. 6 and 7 and described below. Elements and features of the embodiment shown in FIGS. 6 and 7 that correspond to elements and features of the embodiment of FIGS. 1-5 and 14 are designated hereinafter in the 100 series of reference numbers.

The conveyor cleaning brush assembly 102 illustrated in FIGS. 6 and 7 includes a dust collection system indicated generally at 188. The dust collection system 188 includes a hood 189, at least partially enclosing the brush 114, and a vacuum chamber assembly 180.

The hood 189 includes an enclosure 190 directly or indirectly coupled to the carriage 106 for movement with the carriage 106 along the beam 122. The enclosure 190 can have any shape and size for this purpose, and in some embodiments (see FIGS. 6 and 7) corresponds generally to the shape and size of the brush 114. Also, the enclosure 190 can be manufactured from a number of different suitable materials (including without limitation sheet metal, plastic, fiberglass, and the like), and can be constructed from a single element or any number of elements coupled together in any suitable manner.

The hood 189 further includes mounting brackets 191 used to couple the enclosure 190 to the carriage 106 as just described. The mounting brackets 191 can be separate or integrally formed with the enclosure 190 or carriage 106. In the illustrated embodiment of FIGS. 6 and 7, the mounting brackets 191 are bolted to the enclosure 190 and carriage 106. In other embodiments, the enclosure 190 can be directly or indirectly coupled to the carriage 106 by rivets, pins, nails, screws, or other conventional fasteners, by welding, brazing, or adhesive or cohesive bonding material, by clips, magnets, clamps, or inter-engaging elements, and the like.

The enclosure 190 can enclose any portion of the brush 114, and can cooperate with the conveyor surface 101 when engaged therewith to substantially entirely enclose the brush 114. For example, the enclosure 190 illustrated in FIGS. 6 and 7 substantially entirely encloses the brush 114 when the enclosure 190 is engaged with the conveyor surface 101, leaving only a relatively small opening 193 between a back wall 192 of the enclosure 190 and the conveyor surface 101 so that the conveyor surface 101 is largely undisturbed and free from contact with the conveyor cleaning brush assembly 102 prior to being engaged by the brush 114. As shown in the illustrated embodiment of FIGS. 6 and 7, the opening 193 is sufficiently small to enable a significant vacuum to by maintained within the enclosure 190 during operation of the dust collection system 188 (described in greater detail below), and can run substantially the entire width of the brush 114. In other embodiments, the shape and size of the opening 193 can be different (e.g., thinner, extending along less than the entire length of the brush 114, and the like) while still enabling a significant vacuum to be maintained within the enclosure 190.

The enclosure 190 illustrated in FIGS. 6 and 7 includes a number of bristles 194 located on that portion of the enclosure 190 adjacent the conveyor surface 101 being cleaned. The bristles 194 can contact the conveyor surface 101 in order to at least partially seal the enclosure 190 upon the conveyor surface 101 moving past the enclosure 190. The bristles 194 can be made of any suitable material, including those described above in connection with the bristles of the brush 14. Although the bristles 194 are used as a seal in the embodiment of FIGS. 6 and 7, other types of seals can be utilized in other embodiments for the same purpose. For example, flexible flaps comprising rubber, urethane, or other elastomeric material, fabric, and the like can be coupled to the edges of the enclosure 190 that engage the conveyor surface 101. As other examples, wear members comprising UHMW, plastic, or other material can be coupled to the enclosure 190 and/or one or more rollers can be rotatably coupled to the enclosure 190 at the edges engaging the conveyor surface 101.

Although the various types of seals described above can be located on the enclosure 190 to engage the conveyor surface 101 during operation of the dust collection system 188, in other embodiments, a clearance can exist between the seals and the conveyor surface 101 while still enabling a vacuum to be maintained within the enclosure 190 as will be described in greater detail below.

In some embodiments, one or more electricity-conducting elements (e.g., wires or other conductors) can be coupled to the bristles 194 and/or enclosure 190, and can be electrically coupled to ground in order to help prevent static charge buildup on the hood 189 and/or conveyor surface 101. For example, a grounding wire 195 is coupled to the bristles 194 in the illustrated embodiment of FIGS. 6 and 7. The grounding wire 195 extends to and is electrically coupled to the carriage 106 and to a ground wire associated with the motors 161, 162 (not shown).

With continued reference to the illustrated embodiment of FIGS. 6 and 7, the enclosure 190 has a number of internal baffles 196 for channeling airflow from the conveyor surface 101 to an outlet 197 of the enclosure 190. Although not required, the baffles 196 can significantly improve airflow within the enclosure 190, thereby improving the efficiency of the dust collection system 188.

The hood 189 illustrated in FIGS. 6 and 7 also includes a duct 198 extending from the outlet 197 of the hood 189 to carry air and debris away from the enclosure to downstream equipment. The duct 198 illustrated in FIGS. 6 and 7 also connects to a second outlet 199 of the enclosure 190 located adjacent an end of the brush 114. In this regard, the enclosure 190 can have any number of outlets 197, 199 for carrying air and debris away from different portions of the enclosure 190. The duct 198 can have any shape and size suitable for this purpose.

The duct 198 extending from the enclosure 190 can be connected to a vacuum source (not shown) for drawing air and debris from the enclosure 190. In this manner, debris generated by the brush 114 in cleaning the conveyor surface 101 can be drawn away from the conveyor surface 101 and the equipment on which the conveyor cleaning brush assembly 102 is installed. In some embodiments, the duct 198 is connected to or comprises a flexible duct enabling the hood 189 to move with the carriage 106 during operation of the conveyor cleaning brush assembly 102. In other embodiments, the duct 198 is connected to another air flow component (e.g., vacuum chamber assembly 180 shown in FIGS. 6 and 7) also enabling such movement of the hood 189.

The vacuum chamber assembly 180 illustrated in FIGS. 6 and 7 includes a duct 181 extending along and coupled to the beam 122. The duct 181 can have any cross-sectional shape and size desired, and in the illustrated embodiment is substantially rectangular.

The vacuum chamber assembly 180 further includes mounting brackets 182 used to couple the duct 181 to the beam 122 as just described. The mounting brackets 182 can be separate or integrally formed with the duct 181 or beam 122. In the illustrated embodiment of FIGS. 6 and 7, the mounting brackets 182 are bolted to the duct 181 and beam 122. In other embodiments, the duct 181 can be directly or indirectly coupled to the beam 122 by rivets, pins, nails, screws, or other conventional fasteners, by welding, brazing, or adhesive or cohesive bonding material, by clips, magnets, clamps, or inter-engaging elements, and the like.

The duct 181 illustrated in FIGS. 6 and 7 is coupled to the duct 198 extending from the enclosure 190, thereby enabling air and debris to be moved from the enclosure 190, into and through the duct 198 extending from the enclosure 190, and then into and through the duct 181 of the vacuum chamber assembly 180 to a downstream bag or other debris collection container (not shown). To enable the enclosure 190 to move with the carriage 106, the duct 198 extending from the enclosure 190 is movable along the duct 181 of the vacuum chamber assembly 180. In particular, the duct 181 of the vacuum chamber assembly 180 has an elongated aperture 183 along which the duct 198 extending from the enclosure 190 can move as the enclosure 190 and carriage 106 move. To reduce vacuum loss along the aperture 183, the duct 181 of the vacuum chamber assembly 180 is provided with a seal 186 along the aperture 183 and with bristles 187 flanking the aperture. The seal 186 and bristles 187 can take any of the forms described above in connection with the seals used for the enclosure-to-conveyor surface interface, and enable the duct 198 extending from the enclosure 190 to move freely along the duct 181 of the vacuum chamber assembly 180 while still maintaining vacuum through the dust collection system 188. Other embodiments of the present invention are provided only with the seal 186 or with the bristles 187, while still performing adequately.

The duct 181 of the vacuum chamber assembly 180 (if used) can run along any length of the beam 122, and in some embodiments runs at least along the range of positions to which the carriage 106 can be moved.

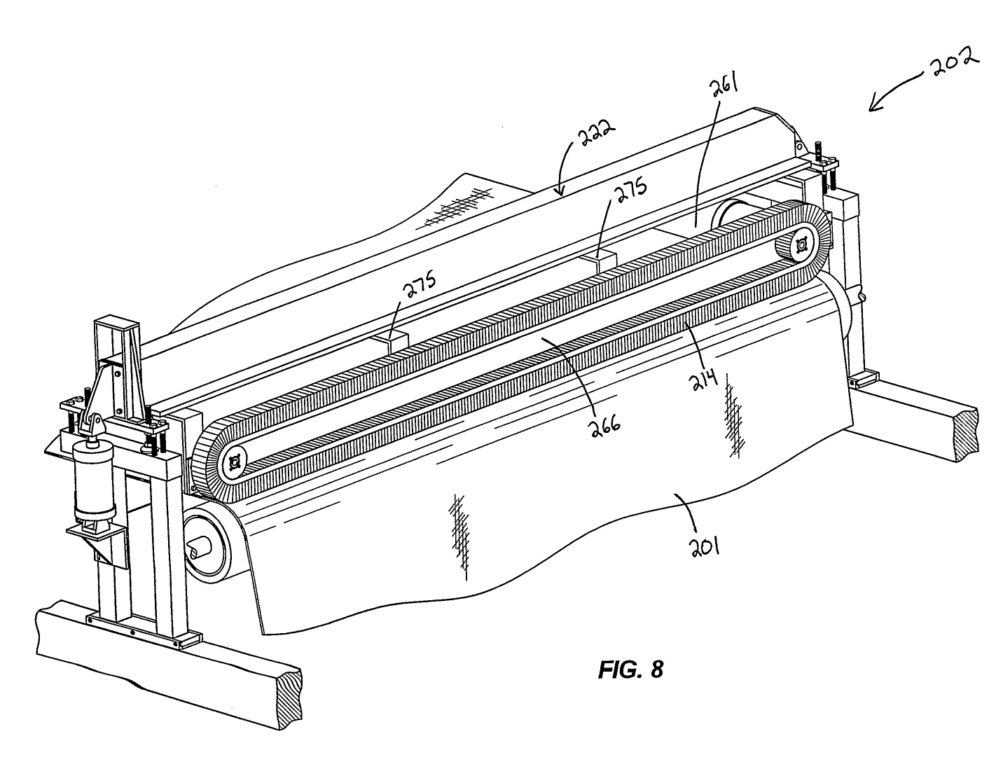

FIG. 8 illustrates another conveyor cleaning brush assembly according to the present invention. The elements and features of this embodiment are similar in many ways to elements and features in the embodiment described above and illustrated in FIGS. 1-5 and 14. Accordingly, the following description focuses primarily upon those elements and features that are different from the embodiment described above in connection with FIGS. 1-5 and 14. Reference should be made to the above description accompanying FIGS. 1-5 and 14 for additional information regarding the elements, features, and possible alternatives to the elements and features of the conveyor cleaning brush assembly illustrated in FIG. 8 and described below. Elements and features of the embodiment shown in FIG. 8 that correspond to elements and features of the embodiment of FIGS. 1-5 and 14 are designated hereinafter in the 200 series of reference numbers.

Unlike the conveyor cleaning brush assembly 2 illustrated in FIGS. 1-5 and 14, the conveyor cleaning brush assembly 202 illustrated in FIG. 8 does not utilize a carriage. Instead, the brush 214 is dimensioned to extend substantially the entire length of the conveyor surface 201. The brush 214 in the embodiment of FIG. 8 is coupled to the beam 222 by brackets 275 coupled to a mounting plate 266 of the brush 214. In other embodiments, the brush 214 or brush mounting plate 266 could instead be coupled to the beam 222 by a frame or other structure, or could be coupled directly to the beam 222. In the illustrated embodiment of FIG. 8, the brackets 275 are bolted to the mounting plate 266 and to the beam 222. Alternatively, the brush 214 or brush mounting plate 266 can be directly or indirectly coupled to the beam 222 by rivets, pins, nails, screws, or other conventional fasteners, by welding, brazing, or adhesive or cohesive bonding material, by clips, magnets, clamps, or inter-engaging elements, and the like.

With continued reference to the embodiment of FIG. 8, the brush motor 261 can be mounted to the mounting plate 266 in a manner similar to that of the brush motor 61 in the embodiment illustrated in FIGS. 1-5 and 14. In other embodiments, the brush motor 261 can instead be directly or indirectly mounted to the beam 222, such as in any of the manners described above regarding the manner in which the brush 214 is coupled to the beam 222.

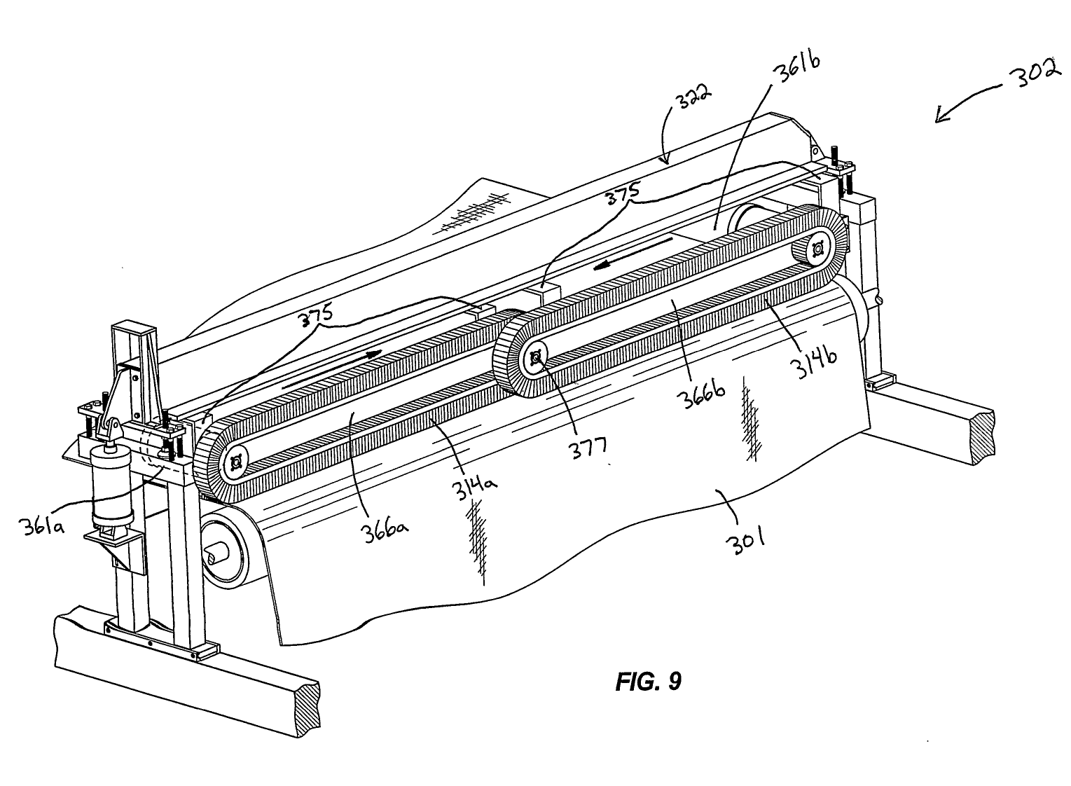

FIG. 9 illustrates another conveyor cleaning brush assembly according to the present invention. The elements and features of this embodiment are similar in many ways to elements and features in the embodiment described above and illustrated in FIGS. 1-5 and 14. Accordingly, the following description focuses primarily upon those elements and features that are different from the embodiment described above in connection with FIGS. 1-5 and 14. Reference should be made to the above description accompanying FIGS. 1-5 and 14 for additional information regarding the elements, features, and possible alternatives to the elements and features of the conveyor cleaning brush assembly illustrated in FIG. 9 and described below. Elements and features of the embodiment shown in FIG. 9 that correspond to elements and features of the embodiment of FIGS. 1-5 and 14 are designated hereinafter in the 300 series of reference numbers.

Like the conveyor cleaning brush assembly 202 illustrated in FIG. 8, the conveyor cleaning brush assembly 302 illustrated in FIG. 9 does not utilize a carriage. However, the conveyor cleaning brush assembly 302 has two brushes 314a, 314b together dimensioned to extend substantially the entire length of the conveyor surface 301. The brushes 314a, 314b are each driven by respective motors 361a, 361b. With the exception of a common axle 377 shared by the brushes 314a, 314b, each brush 314a, 314b and respective motor 361a, 361b has substantially the same construction as the brush 14 and motor 61 described above in connection with the embodiment of FIGS. 1-5 and 14.

The brushes 314a, 314b in the embodiment of FIG. 9 are coupled to the beam 322 by brackets 375 coupled to respective mounting plates 366a, 366b of the brushes 314a, 314b. In other embodiments, the brushes 314a, 314b or brush mounting plates 366a, 366b could instead be coupled to the beam 322 by one or more frames or other structures, by a common mounting plate, or could be coupled directly to the beam 322. In the illustrated embodiment of FIG. 9, the brackets 375 are bolted to the mounting plates 366a, 366b and to the beam 322. Alternatively, the brushes 314a, 314b or brush mounting plates 366a, 366b can be directly or indirectly coupled to the beam 322 by rivets, pins, nails, screws, or other conventional fasteners, by welding, brazing, or adhesive or cohesive bonding material, by clips, magnets, clamps, or inter-engaging elements, and the like.

With continued reference to the embodiment of FIG. 9, the brush motors 361a, 361b can be mounted to the mounting plates 366a, 366b in a manner similar to that of the brush motor 61 in the embodiment illustrated in FIGS. 1-5 and 14. In other embodiments, the brush motors 361a, 361b can instead be directly or indirectly mounted to the beam 322, such as in any of the manners described above regarding the manner in which the brushes 314a, 314b are coupled to the beam 322.

The brushes 314a, 314b illustrated in FIG. 9 rotate in opposite directions, as indicated by the arrows. In this manner, the brushes 314a, 314b can help distribute lateral force applied to the conveyor surface 301. With sufficient lateral force upon the conveyor surface 301 in one direction, the conveyor surface 301 could slip laterally. Therefore, in those applications where relatively high force is to be supplied by the conveyor cleaning brush assembly 302 to the conveyor surface 301, or where the conveyor cleaning brush assembly 302 is relatively long (i.e., in the cross-machine direction), two or more brushes 314a, 314b rotating in different directions can be utilized. In other embodiments, the brushes 314a, 314b can be driven in the same direction. Also, in other embodiments, the same motor 361 can be connected to two or more brushes 314a, 314b to drive the brushes 314a, 314b in the same or different directions.

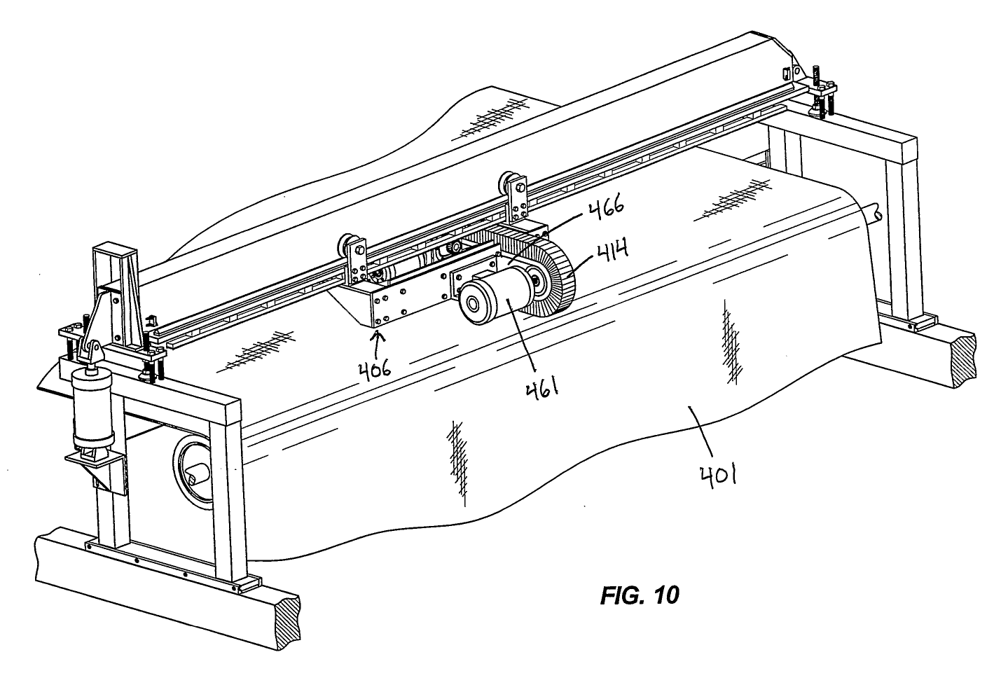

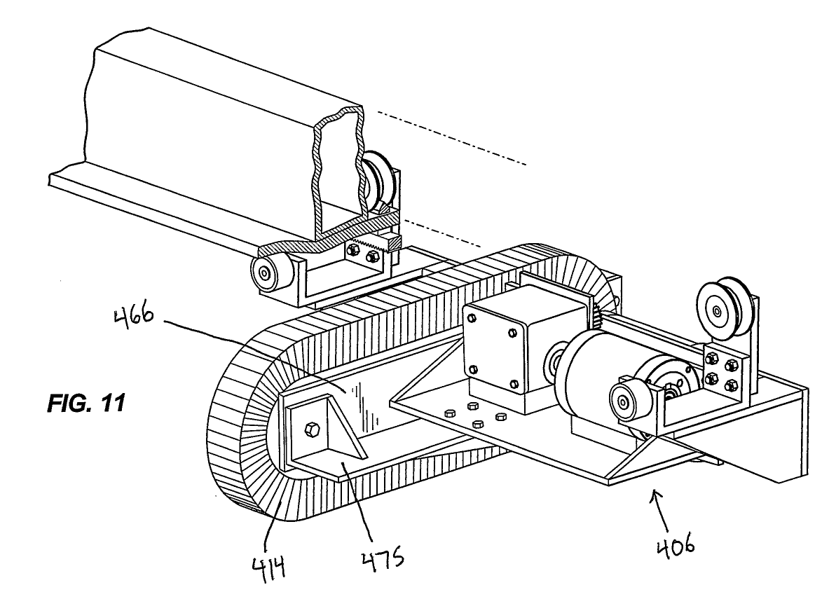

FIGS. 10 and 11 illustrate another conveyor cleaning brush assembly according to the present invention. The elements and features of this embodiment are similar in many ways to elements and features in the embodiment described above and illustrated in FIGS. 1-5 and 14. Accordingly, the following description focuses primarily upon those elements and features that are different from the embodiment described above in connection with FIGS. 1-5 and 14. Reference should be made to the above description accompanying FIGS. 1-5 and 14 for additional information regarding the elements, features, and possible alternatives to the elements and features of the conveyor cleaning brush assembly illustrated in FIGS. 10 and 11 and described below. Elements and features of the embodiment shown in FIGS. 10 and 11 that correspond to elements and features of the embodiment of FIGS. 1-5 and 14 are designated hereinafter in the 400 series of reference numbers.

The embodiment of FIGS. 10 and 11 is an example of the manner in which the brush 414 can be oriented to run in a direction other than in the cross-machine direction. The brush 414 illustrated in FIGS. 10 and 11 is oriented to run substantially in the machine direction. In other embodiments, the brush 414 can be oriented to run in any other direction between the machine and cross-machine directions.

The brush 414 illustrated in FIGS. 10 and 11 is coupled to the carriage 406 by brackets 475 coupled to a mounting plate 466 of the brush 414. In other embodiments, the brush 414 or brush mounting plate 466 could instead be coupled to the carriage 406 by a frame or other structure, or could be coupled directly to the carriage 406. In the illustrated embodiment of FIGS. 10 and 11, the brackets 475 are bolted to the mounting plate 466 and to the carriage 406. Alternatively, the brush 414 or brush mounting plate 466 can be directly or indirectly coupled to the carriage 406 by rivets, pins, nails, screws, or other conventional fasteners, by welding, brazing, or adhesive or cohesive bonding material, by clips, magnets, clamps, or inter-engaging elements, and the like.

In the illustrated embodiment of FIGS. 10 and 11, the brush 414 and motor 461 are coupled to a carriage 406 as described above. However, it should be noted that the brushes in any of the other embodiments of the present invention (e.g., those not utilizing a carriage) can be oriented in any of the manners described herein with reference to FIGS. 10 and 11.

The brush 414 illustrated in FIGS. 10 and 11 is driven in a direction opposite that of the conveyor surface 401 being cleaned (i.e., wherein that portion of the brush 414 engaging the conveyor surface 401 runs in a direction opposite the machine direction). In other embodiments, the brush 414 runs in the same direction as the conveyor surface 401 being cleaned, in which case the brush 414 can be driven at a faster or slower speed in order to provide a degree of cleaning action by the brush 414.

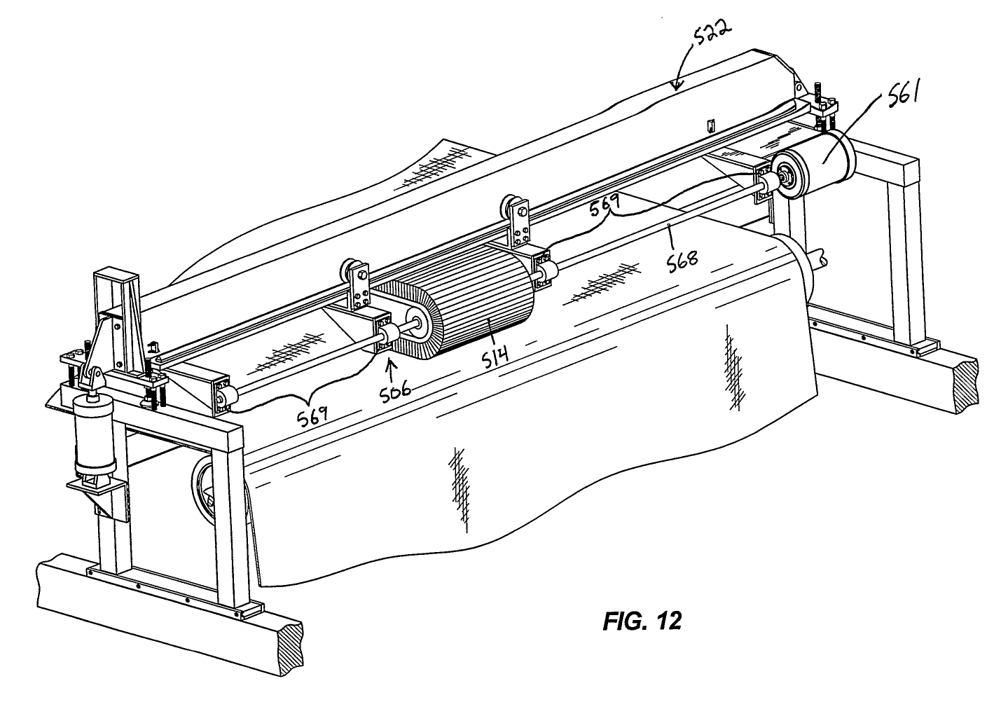

FIG. 12 illustrates another conveyor cleaning brush assembly according to the present invention. The elements and features of this embodiment are similar in many ways to elements and features in the embodiment described above and illustrated in FIGS. 10 and 11. Accordingly, the following description focuses primarily upon those elements and features that are different from the embodiment described above in connection with FIGS. 10 and 11. Reference should be made to the above description accompanying FIGS. 10 and 11 for additional information regarding the elements, features, and possible alternatives to the elements and features of the conveyor cleaning brush assembly illustrated in FIG. 12 and described below. Elements and features of the embodiment shown in FIG. 12 that correspond to elements and features of the embodiment of FIGS. 10 and 11 are designated hereinafter in the 500 series of reference numbers.

As mentioned above, the brush motor 561 need not necessarily be carried by the carriage 506. In the illustrated embodiment of FIG. 12, for example, the brush motor 561 is mounted to the beam 522, and drives the brush 514 through an axle 568 rotatably supported by bearings 569 on the beam 522 and carriage 506. The brush motor 561 can be mounted to the beam 522 in any suitable manner, such as by a mounting bracket (not shown).

The embodiment of FIG. 12 is another example of the manner in which the brush 514 can be oriented to run in a direction other than in the cross-machine direction. Like the embodiment of FIGS. 10 and 11, the brush 514 illustrated in FIG. 12 is oriented to run substantially in the machine direction. In other embodiments, the brush 514 can be oriented to run in the cross-machine direction and in any direction between the machine and cross-machine directions. In such cases, the mounting location and orientation of the brush motor 561 coupled to the beam 522 can be changed accordingly, and/or a suitable power transmission coupling (e.g., a universal joint, gearbox, and the like) can be used to connect the brush motor 561 to the brush 514.

The embodiment of FIG. 12 also illustrates the use of a common drive motor 561 to drive both the brush 514 and the trolley 506. In this regard, the shaft 568 can include a spiral ball spline to transmit power to the brush 514 and to also provide trolley movement via the bearings 569. In some embodiments, the motor direction can be reversed at the end of the trolley travel, such as to return the brush 514 and trolley 506 to a point of origin.

The embodiment of FIG. 12 is also an example of the fact that the brush 514 can have a number of different sizes and shapes while still falling within the spirit and scope of the present invention. In this regard, the brush 514 illustrated in FIG. 12 is substantially thicker than those shown in FIGS. 1-3 and 6-11. Thicker and thinner brushes 514 can also be utilized in connection with any of the embodiments described and illustrated herein.

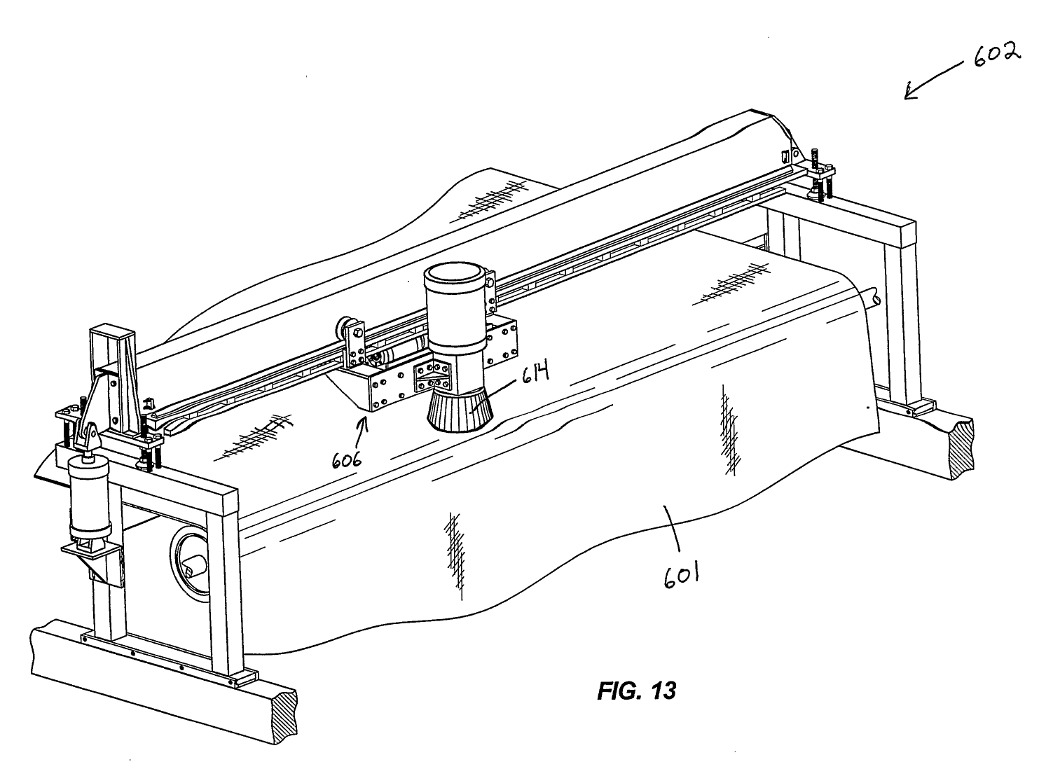

FIG. 13 illustrates another conveyor cleaning brush assembly according to the present invention. The elements and features of this embodiment are similar in many ways to elements and features in the embodiment described above and illustrated in FIGS. 1-5 and 14. Accordingly, the following description focuses primarily upon those elements and features that are different from the embodiment described above in connection with FIGS. 1-5 and 14. Reference should be made to the above description accompanying FIGS. 1-5 and 14 for additional information regarding the elements, features, and possible alternatives to the elements and features of the conveyor cleaning brush assembly illustrated in FIG. 13 and described below. Elements and features of the embodiment shown in FIG. 13 that correspond to elements and features of the embodiment of FIGS. 1-5 and 14 are designated hereinafter in the 600 series of reference numbers.

The conveyor cleaning brush assembly 602 illustrated in FIG. 13 utilizes a brush 614 that spins about a single axis rather than about two or more axes. The brush 614 can be directly or indirectly coupled to the carriage 606 by a bracket, frame, or other structure, by rivets, pins, nails, screws, bolts, or other conventional fasteners, by welding, brazing, or adhesive or cohesive bonding material, by clips, magnets, clamps, or inter-engaging elements, and the like. The brush 614 has a substantially vertical orientation in FIG. 13, but can have other orientations in which the brush 614 still engages and cleans the conveyor surface 601.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention as set forth in the appended claims. For example, the various embodiments (and alternatives thereto) of the present invention described above and illustrated in the figures are not mutually exclusive of one another. With the exception of features, elements, and manners of operation that are mutually exclusive of or are inconsistent with one another, the features, elements and manners of operation of any of the embodiments can be employed in any of the other embodiments in any combination.

As another example, and with reference only to the embodiment of FIGS. 1-5 for ease of discussion (it being understood that the following description is equally applicable to all embodiments disclosed herein), the conveyor cleaning brush assembly 2 utilizes a beam 22 spanning across at least a portion of a conveyor surface 1 and supported by supports 34, 35 located on different sides of the conveyor surface 1. However, in other embodiments, the beam 22 can be cantilevered from a support 34, 35 on either side of the conveyor surface 1, in which cases the beam 22 and support 34, 35 can be selected to have a strength sufficient to support the carriage 6 and the brush assembly 5 in such a cantilevered fashion. Also, in such embodiments, the beam 22 can be pivoted about a fulcrum (not shown) located between the actuator 28 and the carriage 6 and brush assembly 5, thereby enabling the beam 22 to be pivoted with respect to the conveyor surface 1 in order to move the brush 14 into and out of engagement with the conveyor surface 1 (or to adjust the degree of engagement of the brush 14 and the conveyor surface 1).

In some embodiments, a single carriage 6 is movable along the beam 22 as described above. Although the present description is with reference again to the embodiment of FIGS. 1-5, it will be understood that this description applies equally to all of the other embodiments disclosed herein. As an alternative to a single carriage 6, some embodiments utilize two or more carriages 6 coupled to and movable along the same beam 22. In such embodiments, the carriages 6 can share the same track 23, gear rack 64, and other components by which the carriages 6 are coupled to and movable along the beam 22 as described in greater detail above. In other embodiments, the carriages 6 can be coupled to and movable along different portions of the beam 22, such as to different tracks 23, gear racks 64, and the like on the same beam 22. In those embodiments having two or more carriages 6 coupled to and movable along the same beam 22, the carriages 6 can be independently controlled or can be operated without such independent control. Also, the brushes 14 carried by each carriage 6 can be independently controlled or without such independent control, and can be operated at the same or different speeds and in the same or different directions. In still other embodiments, two or more beams 22 are located at different positions along the machine direction of the conveyor surface 1, in which case each beam 22 can carry one or more carriages 6 for movement along the beams 22 in any of the manners disclosed herein.

As illustrated and described in connection with the embodiment of FIGS. 1-5, the beam 22 can be actuated by an actuator 28 located proximate a side of the conveyor surface 1. Although the present description is with reference again to the embodiment of FIGS. 1-5, it will be understood that this description applies equally to all of the other embodiments disclosed herein. In other embodiments, the beam 22 can be coupled to and movable by an actuators 28 on each sides of the conveyor surface 1. In such embodiments, the beam 22 can be pivoted about either end (e.g., by actuating only one of the actuators 28). Also, such embodiments can enable both ends of the beam 22 to be moved with respect to the conveyor surface 1, such as in movement of the beam 22 toward and away from the conveyor surface 1 while keeping the beam 22 substantially parallel to the conveyor surface 1 or at a desired angle with respect to the conveyor surface 1.

What is claimed is:

1. A conveyor cleaning apparatus for cleaning a conveyor surface moving in a machine direction, the conveyor cleaning assembly comprising:
a carriage movable to different cross-machine positions adjacent the conveyor surface; and
a rotatable brush coupled to and movable with the carriage to the different cross machine positions with respect to the conveyor surface, the rotatable brush having at least one position in which the rotatable brush engages the conveyor surface to remove matter from the conveyor surface.

2. The conveyor cleaning apparatus as claimed in claim 1, wherein the rotatable brush is substantially elongated, and is rotatable about at least two axes spaced apart from one another.

3. The conveyor cleaning apparatus as claimed in claim 1, wherein the rotatable brush is rotatable through an elongated path, and is adapted to be positioned with the elongated path extending substantially in a cross-machine direction.

4. The conveyor cleaning apparatus as claimed in claim 1, wherein the rotatable brush is rotatable through an elongated path, and is adapted to be positioned with the elongated path extending substantially in the machine direction.

5. The conveyor cleaning apparatus as claimed in claim 1, wherein the rotatable brush and the carriage are movable toward and away from the conveyor surface.

6. The conveyor cleaning apparatus as claimed in claim 5, further comprising a beam extending across at least part of the conveyor surface, wherein the carriage and rotatable brush are coupled to and movable along the beam, and are movable toward and away from the conveyor surface by movement of the beam.

7. The conveyor cleaning apparatus as claimed in claim 1, further comprising a beam extending across at least part of the conveyor surface, wherein the carriage and rotatable brush are coupled to and movable along the beam.

8. The conveyor cleaning apparatus as claimed in claim 7, wherein the beam is pivotable to move the carriage and rotatable brush with respect to the conveyor surface.

9. The conveyor cleaning apparatus as claimed in claim 1, further comprising a motor coupled to the carriage and operable to drive the carriage to the different cross-machine positions.

10. The conveyor cleaning apparatus as claimed in claim 1, wherein the motor is coupled to and movable with the carriage.

11. The conveyor cleaning apparatus as claimed in claim 1, further comprising a hood at least partially enclosing the rotatable brush and through which matter is moved away from the rotatable brush.

12. The conveyor cleaning apparatus as claimed in claim 1, further comprising an enclosure in fluid communication with the rotatable brush and a vacuum source to draw matter away from the rotatable brush.

13. A conveyor cleaning apparatus for cleaning a conveyor surface moving in a machine direction, the conveyor cleaning assembly comprising:
a frame past which the conveyor surface moves;
a controller having at least one user-manipulatable control; and
a rotatable brush coupled to the frame and rotatable about at least one axis extending substantially in the machine direction, the rotatable brush movable by the controller into and out of engagement with the conveyor surface.

14. The conveyor cleaning apparatus as claimed in claim 13, further comprising a beam coupled to the frame and extending across at least part of the conveyor surface, wherein the rotatable brush is coupled to and movable along the beam.

15. The conveyor cleaning apparatus as claimed in claim 14, wherein the beam is pivotable to move the rotatable brush with respect to the conveyor surface.

16. The conveyor cleaning apparatus as claimed in claim 13, further comprising:
a beam coupled to the frame and extending across at least part of the conveyor surface; and
an actuator coupled to the beam;
wherein the rotatable brush is coupled to the beam; and
the rotatable brush is movable with respect to the conveyor surface by movement of the beam by the actuator.

17. The conveyor cleaning apparatus as claimed in claim 13, further comprising a carriage to which the rotatable brush is coupled, wherein the carriage is movable to move the rotatable brush to different positions adjacent the conveyor surface.

18. The conveyor cleaning apparatus as claimed in claim 17, further comprising a beam coupled to the frame and extending across at least part of the conveyor surface, wherein the carriage is coupled to and movable along the beam to move the rotatable brush to the different positions.

19. The conveyor cleaning apparatus as claimed in claim 13, wherein the rotatable brush is substantially elongated, and is rotatable about at least two axes spaced apart from one another.

20. The conveyor cleaning apparatus as claimed in claim 13, wherein the rotatable brush is rotatable through an elongated path, and is adapted to be positioned with the elongated path extending substantially in a cross-machine direction.

21. The conveyor cleaning apparatus as claimed in claim 13, wherein the rotatable brush is rotatable through an elongated path, and is adapted to be positioned with the elongated path extending substantially in the machine direction.

22. The conveyor cleaning apparatus as claimed in claim 13, further comprising a motor coupled to the rotatable brush and operable to drive the rotatable brush to different cross-machine positions with respect to the conveyor surface.

23. The conveyor cleaning apparatus as claimed in claim 22, wherein the motor is coupled to and movable with the rotatable brush.

24. The conveyor cleaning apparatus as claimed in claim 13, further comprising a hood at least partially enclosing the rotatable brush and through which matter is moved away from the rotatable brush.

25. The conveyor cleaning apparatus as claimed in claim 13, further comprising an enclosure in fluid communication with the rotatable brush and a vacuum source to draw matter away from the rotatable brush.

26. A conveyor cleaning apparatus for cleaning a conveyor surface, the conveyor cleaning assembly comprising:
a beam adjacent the conveyor surface and extending across the conveyor surface;
a rotatable brush coupled to the beam, the rotatable brush adapted to engage the conveyor surface and to clean the conveyor surface upon rotation of the rotatable brush; and
a motor coupled to the rotatable brush, the rotatable brush movable along the beam by the motor to different positions with respect to the conveyor surface to clean the different positions of the conveyor surface.

27. The conveyor cleaning apparatus as claimed in claim 26, wherein the beam is adapted to be supported on opposite sides of the conveyor surface.

28. The conveyor cleaning apparatus as claimed in claim 26, wherein the beam is pivotable with respect to the conveyor surface.

29. The conveyor cleaning apparatus as claimed in claim 26, wherein the rotatable brush is substantially elongated, and is rotatable about at least two axes spaced apart from one another.

30. The conveyor cleaning apparatus as claimed in claim 29, wherein the at least two axes extend substantially in a machine direction of the conveyor surface.

31. The conveyor cleaning apparatus as claimed in claim 29, wherein the at least two axes extend substantially in a cross-machine direction of the conveyor surface.

32. The conveyor cleaning apparatus as claimed in claim 26, wherein the rotatable brush is rotatable through an elongated path, and is adapted to be positioned with the elongated path extending substantially in a cross-machine direction of the conveyor surface.

33. The conveyor cleaning apparatus as claimed in claim 26, wherein the rotatable brush is rotatable through an elongated path, and is adapted to be positioned with the elongated path extending substantially in a machine direction of the conveyor surface.

34. The conveyor cleaning apparatus as claimed in claim 26, wherein the brush is movable toward and away from the conveyor surface.

35. The conveyor cleaning apparatus as claimed in claim 26, further comprising a motor coupled to the rotatable brush and operable to drive the rotatable brush to different cross-machine positions with respect to the conveyor surface.

36. The conveyor cleaning apparatus as claimed in claim 35, wherein the motor is coupled to and movable with the rotatable brush.

37. The conveyor cleaning apparatus as claimed in claim 26, further comprising a hood at least partially enclosing the rotatable brush and through which matter is moved away from the rotatable brush.

38. The conveyor cleaning apparatus as claimed in claim 26, further comprising an enclosure in fluid communication with the rotatable brush and a vacuum source to draw matter away from the rotatable brush.
